(19) United States
(12) Patent Application Publication
(10) Pub. No.: US 2023/0218080 A1
(43) Pub. Date: Jul. 13, 2023

(54) MODULAR WORKBENCH SYSTEM

(71) Applicant: WHIRLPOOL CORPORATION, BENTON HARBOR, MI (US)

(72) Inventors: ANDREW BOYCE CIZMAR, ST. JOSEPH, MI (US); VENKATA S. DIRISALA, BENTON HARBOR, MI (US); DAVID PETER DRABOUSKY, BENTON HARBOR, MI (US); SCOTT RYAN SPLESE, STEVENSVILLE, MI (US)

(21) Appl. No.: 18/096,731

(22) Filed: Jan. 13, 2023

Related U.S. Application Data
(60) Provisional application No. 63/299,199, filed on Jan. 13, 2022.

(51) Int. Cl. A47B 47/00; B25H 1/00; A47B 96/02; A47B 96/06

(52) U.S. Cl. CPC A47B 47/0091; A47B 96/02; A47B 96/067; B25H 1/00

(57) ABSTRACT

A modular workbench system, a packaged modular workbench system, accessory components, and a universal mounting system are shown and described. The systems and components described herein can provide for improved mobility, organization, ease of use, convenience, and packaging efficiency.

### CROSS-REFERENCE TO RELATED APPLICATIONS

This application claims priority to and the benefit of U.S. Provisional Pat. Application No. 63/299,199 filed Jan. 13, 2022, the entirety of which is incorporated herein by reference.

### BACKGROUND

Work spaces often utilize components such as shelving, cabinets, hangers, pegboards, or the like for organizing tools. Such components can be permanently installed in some examples, or portable in some examples. In some environments, work spaces can also include a bench or worktop for performing tasks, constructing items, or completing repairs.

### BRIEF DESCRIPTION

In one aspect, the disclosure relates to a modular workbench system having a set of nestable cabinets configured to be packaged in a compact, assembled format.

In another aspect, the disclosure relates to a modular workbench system having a set of accessory components and detachable couplings configured to detachably secure the accessory components to a surface of the modular workbench system.

### BRIEF DESCRIPTION OF THE DRAWINGS

In the drawings:

FIG. 1 is a perspective view of an exemplary modular workbench system in accordance with various aspects described herein.

FIGS. 2-12 are front views of exemplary configurations that can be utilized in the modular workbench system of FIG. 1.

FIGS. 13-14 are perspective views of support mechanisms for the exemplary modular workbench system of FIG. 1.

FIGS. 15-19 are perspective views of interior configurations that can be utilized in the modular workbench system of FIG. 1.

FIGS. 20-22 are perspective views of a rail mounting system that can be utilized in the modular workbench system of FIG. 1.

FIGS. 23-27 are front views of the modular workbench system of FIG. 1 illustrating various packaged arrangements.

FIGS. 28-67 illustrate perspective views of a set of modular accessory components that can be utilized in the modular workbench system of FIG. 1.

### DETAILED DESCRIPTION

Aspects of the present disclosure are generally directed to a modular workbench system and accessory components. The system and components described herein can provide for improved mobility, organization, ease of use, convenience, and packaging efficiency.

As used herein, the term “set” or a “set” of elements can be any number of elements, including only one. Additionally, as used herein, “electrical connection” or “electrically coupled” can include a wired or wireless connection. All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader’s understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

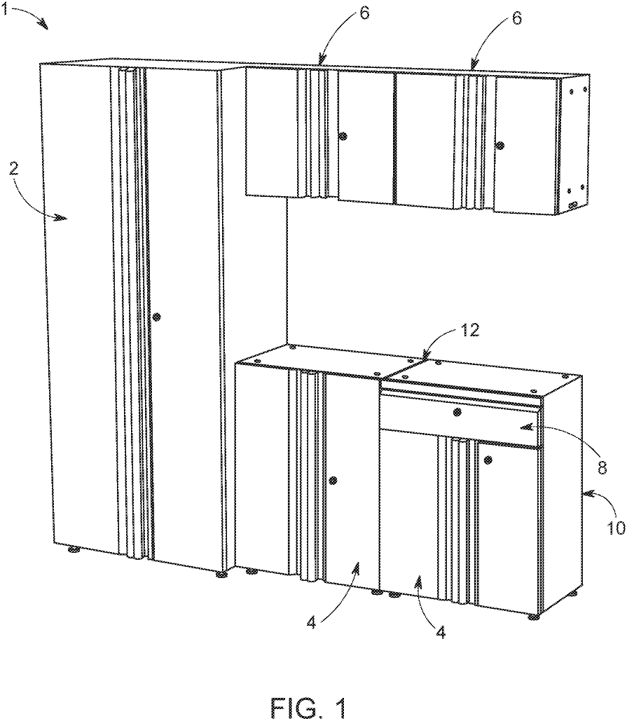

Turning to FIG. 1, one exemplary modular workbench system 1 (or “workbench system” 1) is shown. The workbench system 1 can include one or more cabinets having doors, pull-out drawers, shelves, trays, or the like for storing, managing, securing, tooling, machining, powering, or manipulating an article. In some examples, the workbench system 1 can also include one or more electrical connections, such as for connecting to household power or mains power, or for connecting to a portable power supply, or for providing a connection between a portable power supply and household power, or the like.

The workbench system 1 can include a set of cabinets including one or more large cabinets 2, one or more medium cabinets 4, or one or more small cabinets 6. The workbench system 1 can include any number of cabinets. It will be understood that descriptors such as “large,” “medium,” and “small” are used herein merely for description of relative size and are not limited to any particular dimensional value or range.

In addition, any of the cabinets 2, 4, 6 can include a pull-out drawer 8. Any of the cabinets 2, 4, 6 can include vertically-extending interior spaces. Any of the cabinets 2, 4, 6 can be coupled or secured to one another. Additionally, or alternatively, any of the cabinets 2, 4, 6 can be secured or coupled to a wall, ceiling, or floor. A worktop 12 can also be included in the workbench system 1. In the example shown, the worktop 12 extends over a top surface of the two medium cabinets 4 though this need not be the case. Additionally, or alternatively, any of the cabinets 2, 4, 6 can include an exterior surface that forms or defines a worktop 12.

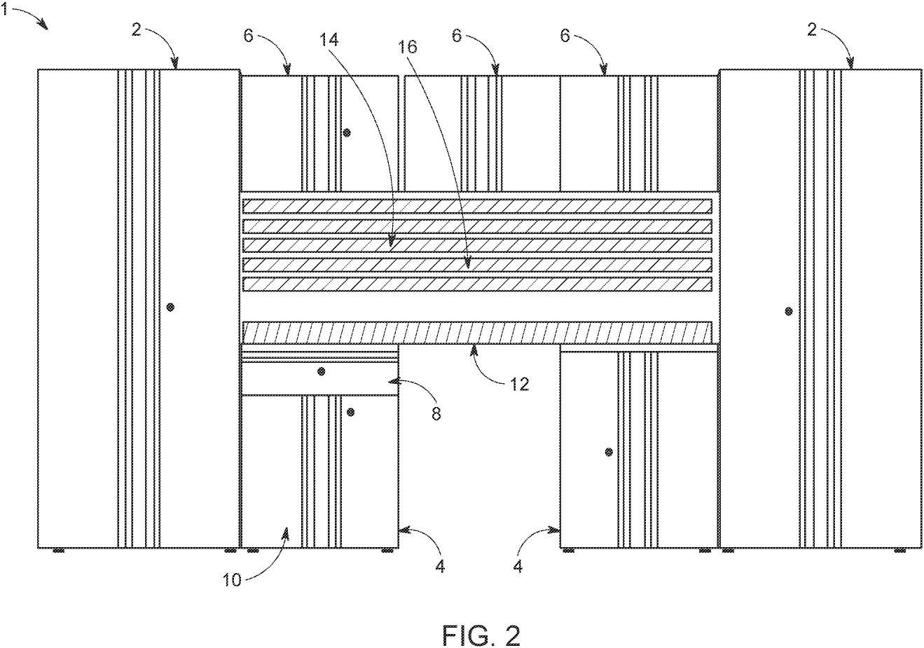

FIG. 2 illustrates the workbench system 1 in a first arrangement. In the example shown, the workbench system 1 includes two large cabinets 2, two medium cabinets 4, and three small cabinets 6. One of the medium cabinets 4 can further include a pull-out drawer 8, thereby forming a drawer cabinet 10. Any number of drawer cabinets 10 can be provided. While the drawer cabinet 10 is illustrated as having a similar size to the medium cabinet 4, this need not be the case and it will be understood that the drawer cabinet 10 can have any suitable size.

An organization surface 14 can also be provided in the workbench system 1. In the example shown, the organization surface 14 is in the form of a slat wall 16 though this need not be the case. Additionally or alternatively, the organization surface 14 can include slots, holes, hooks, pegs, shelves, trays, or the like for storing articles or tools. Any number of organization surfaces 14 can be provided. Additionally or alternatively, any of the cabinets 2, 4, 6 can include an exterior surface that forms or defines an organization surface 14.

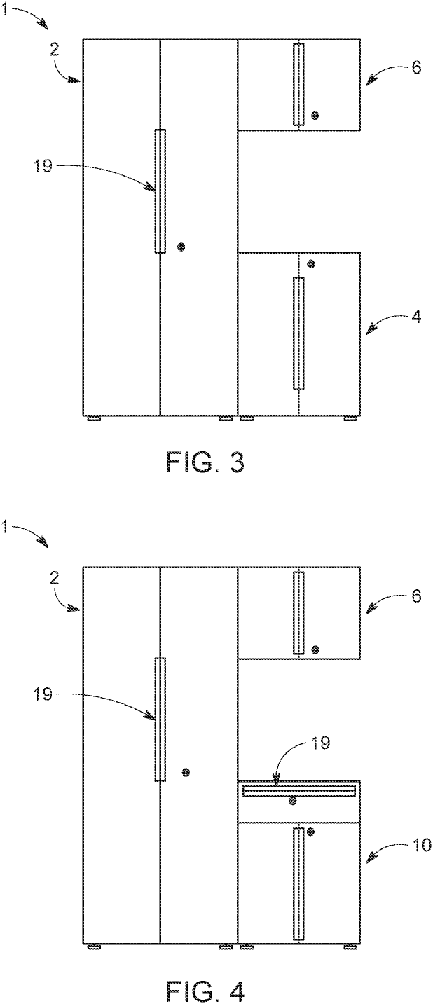

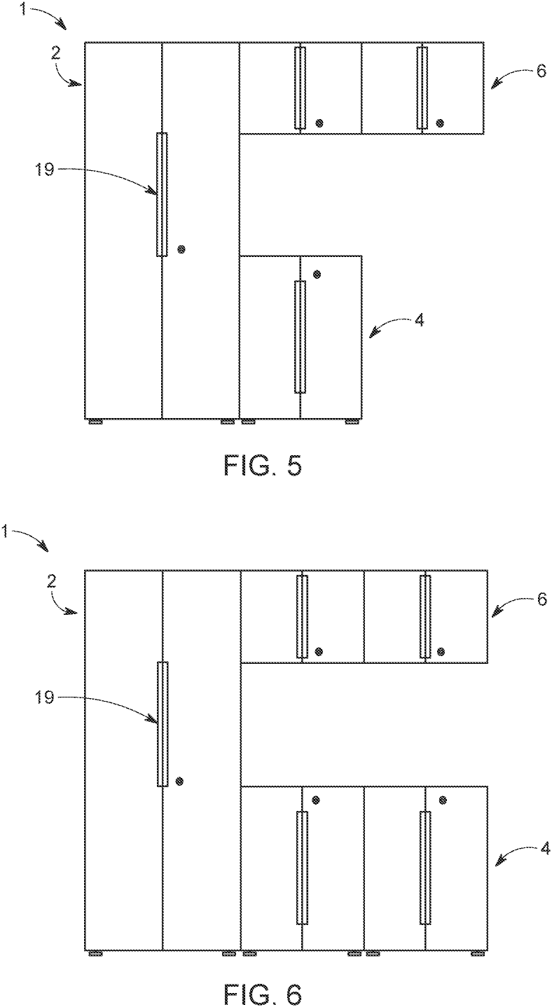

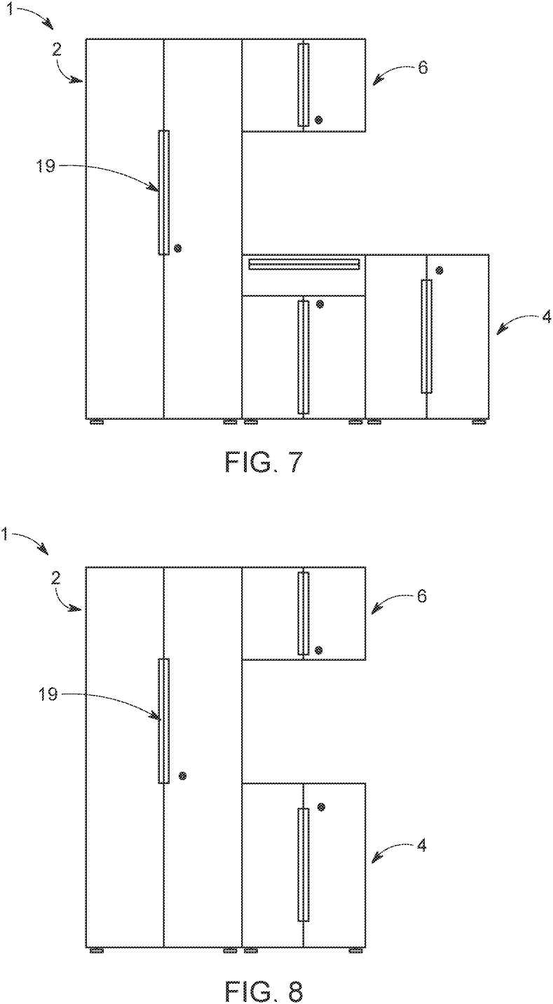

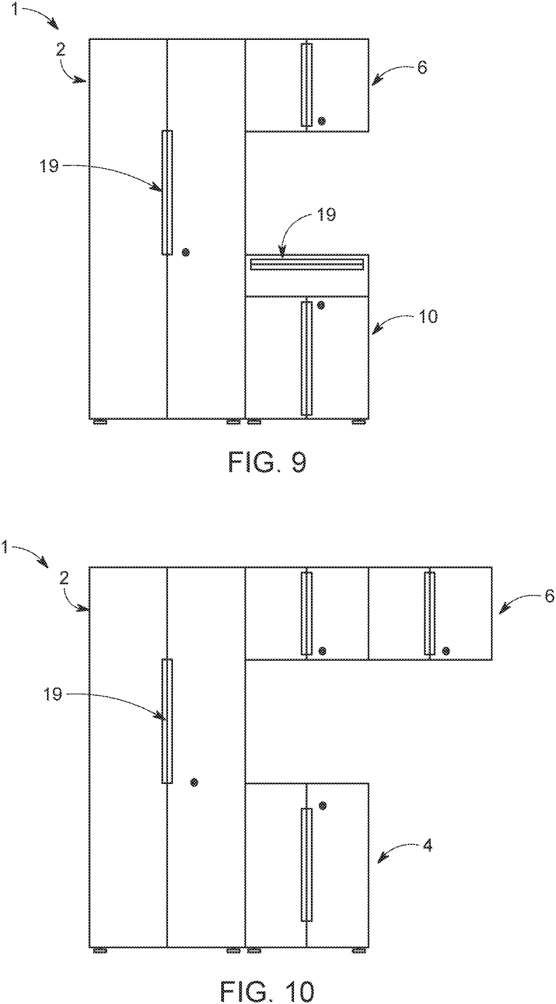

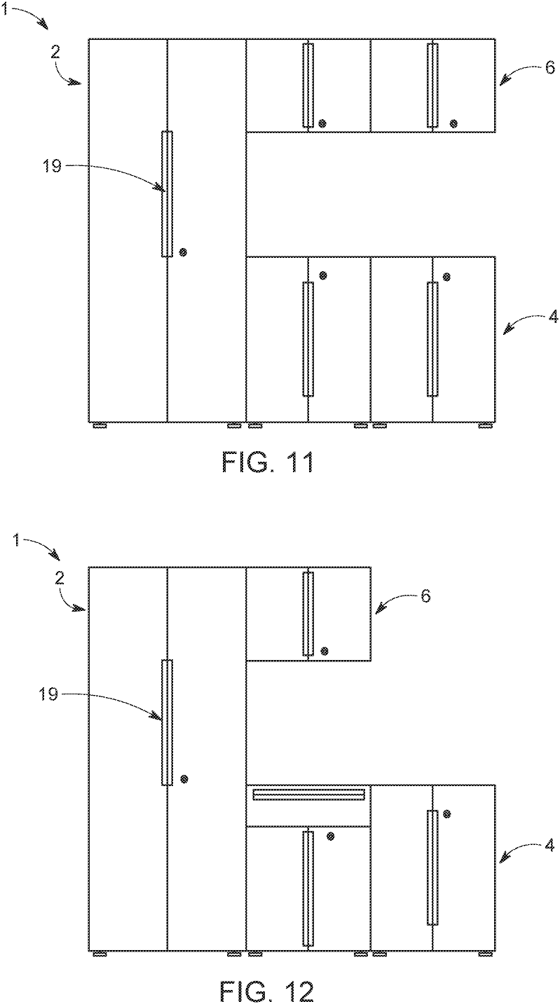

With general reference to FIGS. 3-12, some exemplary configurations are illustrated for the workbench system 1. The workbench system 1 can include a number of modular configurations including, but not limited to, a large cabinet 2 forming one side of the modular configuration and one or more medium cabinets 4, or one or more drawer cabinets 10, or one or more small cabinets 6 positioned adjacent the top or bottom of the large cabinet 2. In some examples, the workbench system 1 can include a top cabinet row and a bottom cabinet row with a gap formed between the rows. Optionally, a worktop such as the worktop 12 (FIG. 1) can be positioned over at least a portion of the bottom cabinet row. In addition, a pocket handle or recess handle 19 can be provided in the workbench system. In some examples, the pocket handle 19 can include a vertically-extending cutout along a portion of the door of the cabinet 2, 4, 6 to form the pocket handle 19. In some examples, the pocket handle 19 can be formed in a flat surface of a door of the cabinet 2, 4, 6, 10. The pocket handle 19 can extend along a vertical portion of the cabinet 2, 4, 6, 10, or along a horizontal portion of the cabinet 2, 4, 6, 10 or along an entire vertical height or horizontal width of the cabinet 2, 4, 6, 10 in some examples. It is also contemplated that the pocket handle 19 can include a plastic overmold over a base in one nonlimiting example.

In addition, an outer surface of the cabinet 2, 4, 6, 10 can include a smooth surface or a textured surface. In some examples, the outer surface can include a tread-style surface with protrusions or corrugations in the outer surface.

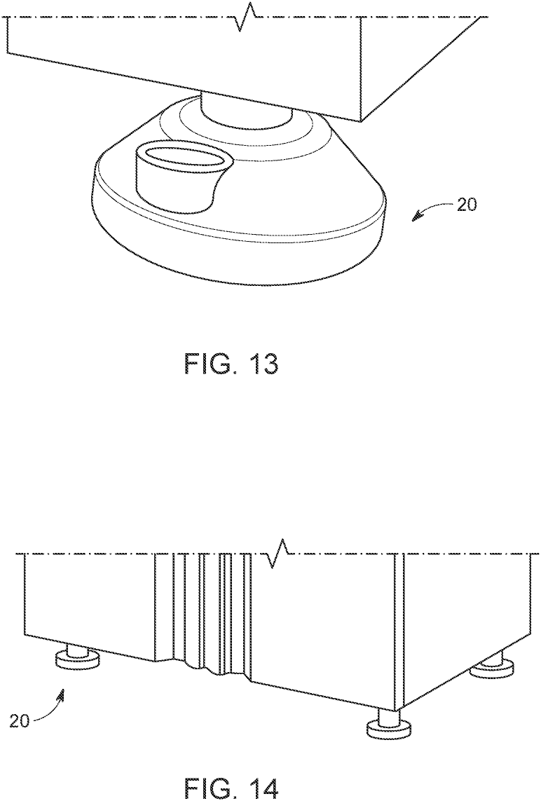

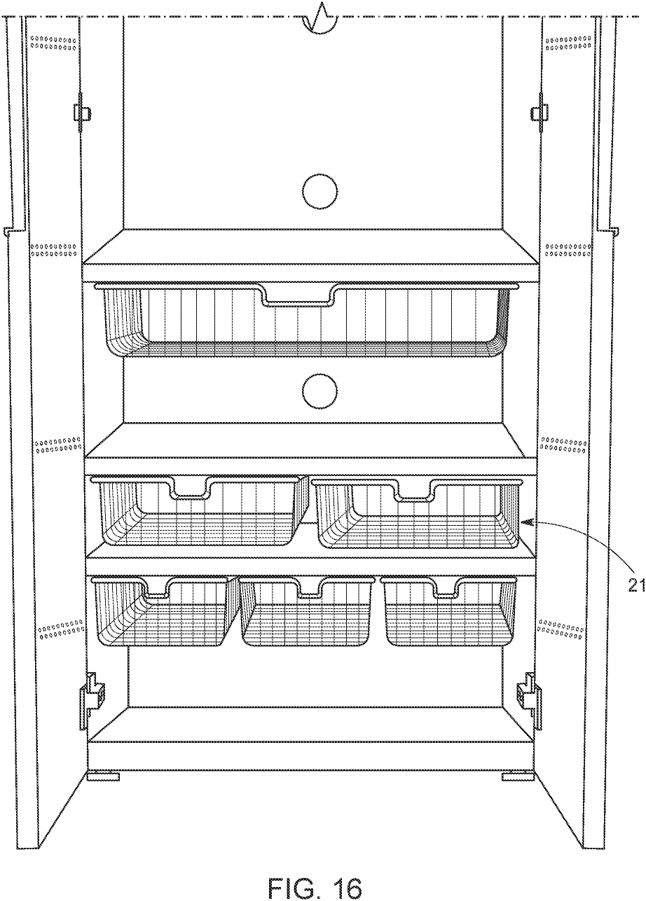

Support mechanisms or feet 20 can be provided in the modular workbench system 1. FIGS. 13-14 illustrate some exemplary support feet 20 positioned at corner regions of the cabinets 2, 4, 6, 10 (FIG. 1). The support feet 20 can be located at any suitable position. The support feet 20 can include a post, e.g. a threaded post in some examples, configured to be received within a base of the cabinet 2, 4, 6, 10 (FIGS. 8-17). The support feet 20 can include a base portion coupled to the post. In some examples the base portion can be solid, e.g. solid rubber, plastic, metal, or the like. In some examples the base portion can include a coating, wrap, or the like, such as a rubber coating over a metal core. In some examples, the support feet can include a height-adjustable mechanism (e.g. FIG. 13) or include a fixed size (e.g. FIG. 14). Additionally or alternatively, casters can be provided for rolling the cabinets 2, 4, 6, 10 across a support surface. Such casters can replace the support feet 20, be fitted over the support feet 20, or be made integral with the support feet 20, in non-limiting examples.

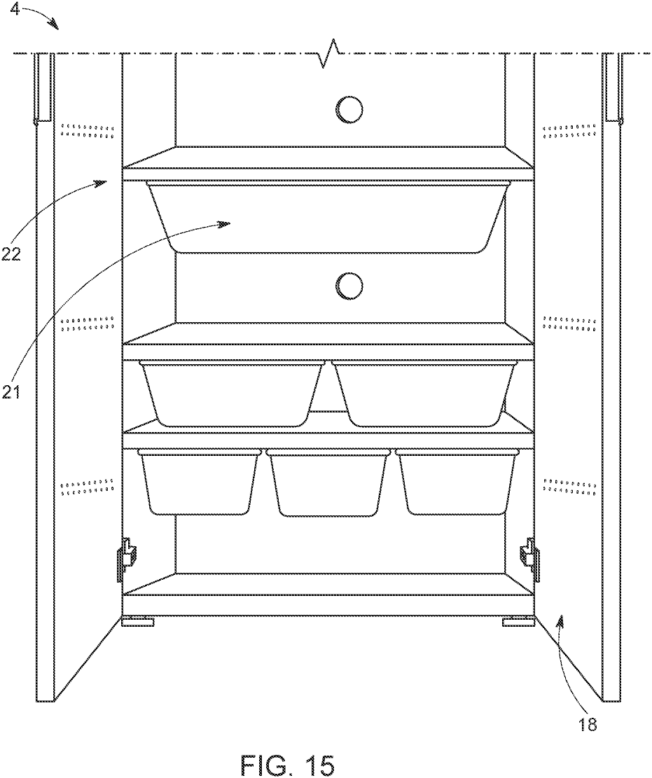

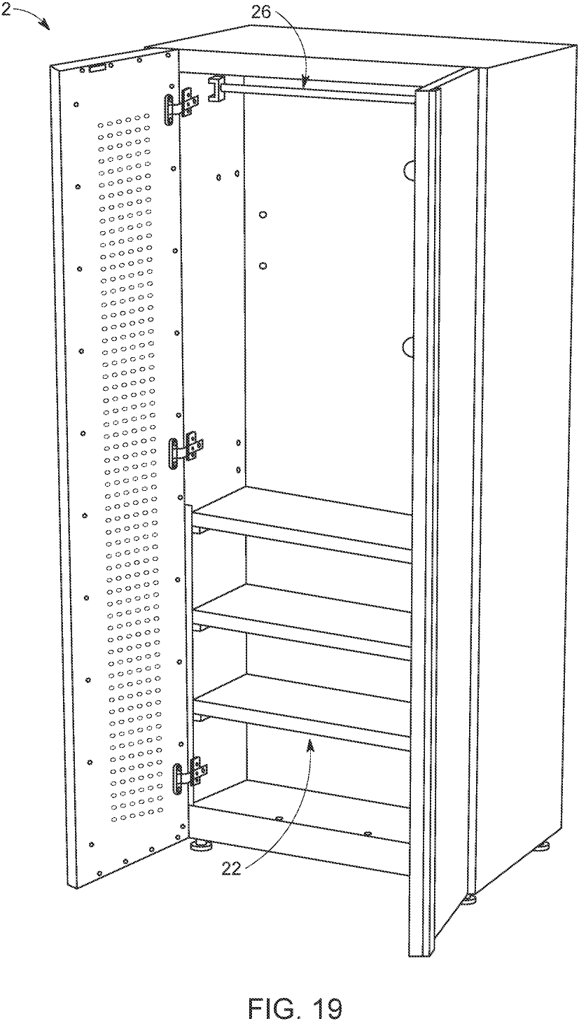

Referring generally to FIGS. 15-19, some exemplary internal configurations are illustrated that can be utilized in the workbench system 1. Some exemplary cabinets 2, 4, 6, 10 are illustrated with doors 18. The doors 18 can include an inner surface with apertures, a pegboard arrangement, or other securing mechanisms in some examples.

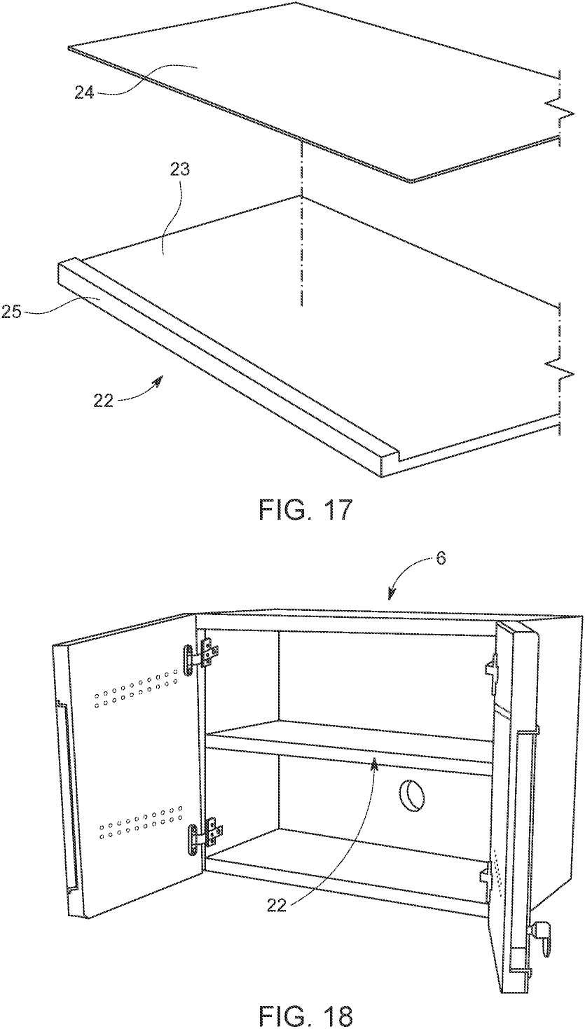

Any of the cabinets 2, 4, 6, 10 (FIG. 1) can also include baskets 21 and shelves 22 as shown in FIGS. 17-18. The baskets 21 can be slidably removed along side rails in some examples. The baskets 21 can have a solid form, an open mesh form, or an open wire form in some examples. It is contemplated that the baskets 21 can be configured to slide beneath shelves 22. In such a case, the shelves 22 can cover or close the open tops of the baskets 21 when stored inside the cabinet 2, 4, 6, 10 (FIG. 1).

In addition, the shelves 22 can be formed as a single piece or include multiple connected components. In one example, the shelves 22 can include a base shelf 23 with an antislip mat 24 coupled to the base shelf. The shelves 22 can further include a roll guard 25 located along a front surface and configured to extend vertically beyond a top surface of the shelf 22. Such a roll guard 25 can prevent objects placed on the shelf 22 from rolling or sliding off the shelf 22.

Other internal components such as hanging rods 26 can also be provided for accommodation of tall or suspended items within the cabinets 2, 4, 6, 10 (FIG. 1). Such a hanging rod 26 can be tension-fit within the cabinet 2, 4, 6, 10 (FIG. 1), or secured to opposing sidewalls of the cabinet 2, 4, 6, 10 (FIG. 1).

It is further contemplated that the shelves 22 can be re-configurable to create additional vertical space within the cabinet 2, 4, 6, 10 (FIG. 1). In some examples, a shelf 22 can be retractable, such as a telescopically-extendable shelf, or a slidable shelf that is received within a wall pocket or recess within the cabinet, or the like. In some examples, a shelf 22 can pivot clockwise or counterclockwise about a side axis, e.g. along a left sidewall or right sidewall of the cabinet 2, 4, 6, 10 (FIG. 1). In some examples, a shelf 22 can pivot vertically about a front or rear axis, e.g. along a front wall or rear wall of the cabinet 2, 4, 6, 10 (FIG. 1). In some examples, a shelf 22 can include a rotatable portion and a second portion, whereby the rotatable portion is configured to pivot or rotate with respect to the second portion to create additional space for tall items within the cabinet 2, 4, 6, 10 (FIG. 1). In some examples, a shelf 22 can include a first portion configured to be removed from a remaining portion of the shelf, whereby removal of the first portion can create additional space for tall items within the cabinet 2, 4, 6, 10 (FIG. 1). In some examples, a shelf 22 or portion thereof can be rotatable about a vertical axis, such as a turnstile, whereby rotation of the shelf or portion can create additional space for tall items within the cabinet 2, 4, 6, 10 (FIG. 1). In this manner, any of the shelves 22 can be configured for adjustment within the cabinet 2, 4, 6, 10 (FIG. 1) to accommodate storage of multiple item sizes.

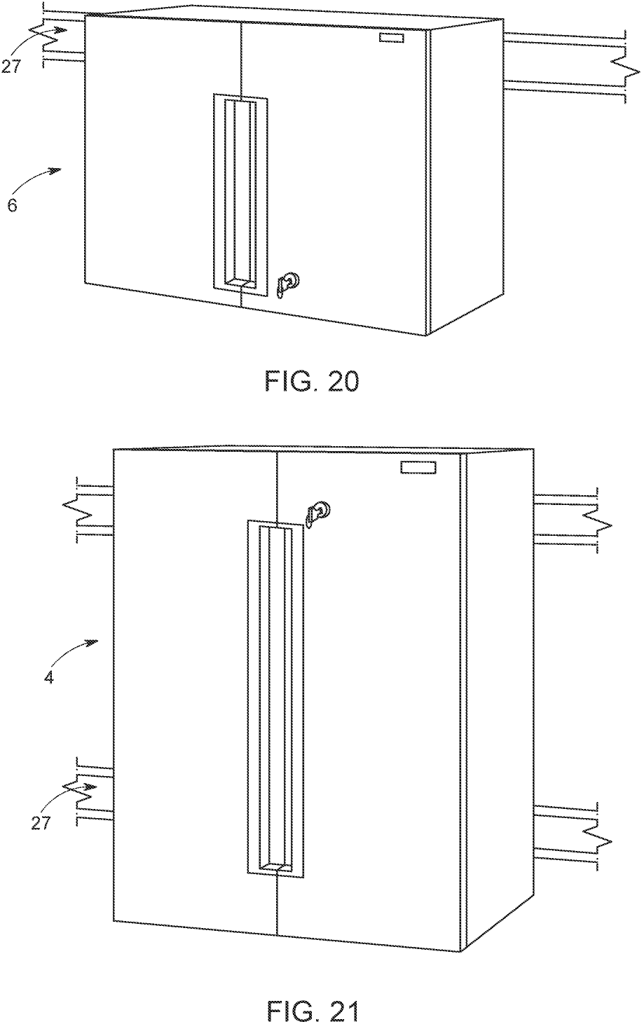

With general reference to FIGS. 20-22, it is further contemplated that any of the cabinets 2, 4, 6, 10 (FIG. 1) can be configured to mount or secure to a wall. In the illustrated example, a rail 27 and mounting bracket 28 can be provided. The mounting bracket 28 can be coupled to a rear surface of any of the cabinets 2, 4, 6, 10 (FIG. 1). The mounting bracket 28 can be configured to be received by the rail 27. In some examples, the mounting bracket 28 can include a projection configured to be received within a recess of the rail 27. In some examples, the mounting bracket 28 can be configured to slide within the rail 27. Multiple mounting brackets 28 can be utilized to secure the cabinet 2, 4, 6, 10 (FIG. 1) to corresponding rails 27.

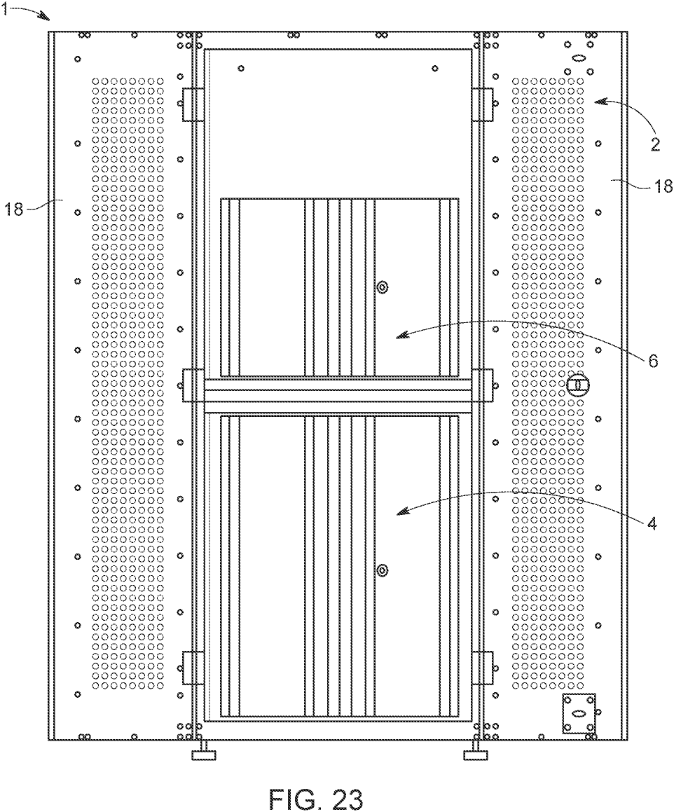

Referring now to FIGS. 23-27, various packaging arrangements and options for the workbench system 1 are illustrated. It will be understood that such examples are provided for illustration purposes and do not limit the disclosure in any way. Other packaging arrangements can be provided.

In FIG. 23, the workbench system 1 is illustrated in a first packaged arrangement. It is contemplated that portions or components of the workbench system 1 can form a nested arrangement wherein a single cabinet, e.g. the large cabinet 2, can house other cabinets or components of the workbench system 1. In the illustrated example, one medium cabinet 4 and one small cabinet 6 can fit within an interior space of the large cabinet 2. In one option, the small cabinet 6 and the medium cabinet 4 can both fit vertically, e.g. upright, within the large cabinet 2. In another option, at least one of the small cabinet 6 or medium cabinet 4 can fit horizontally, e.g. laying on one side, within the large cabinet 2. It is contemplated that the medium cabinet 4 and small cabinet 6 can fit entirely within the interior space of the large cabinet 2, such that outer doors 18 of the large cabinet 2 can be closed normally with the medium and small cabinets 4, 6 inside. Such an arrangement can provide for improved packaging efficiency, reduced package volume, or reduced need of packing materials when transporting elements of the workbench system 1.

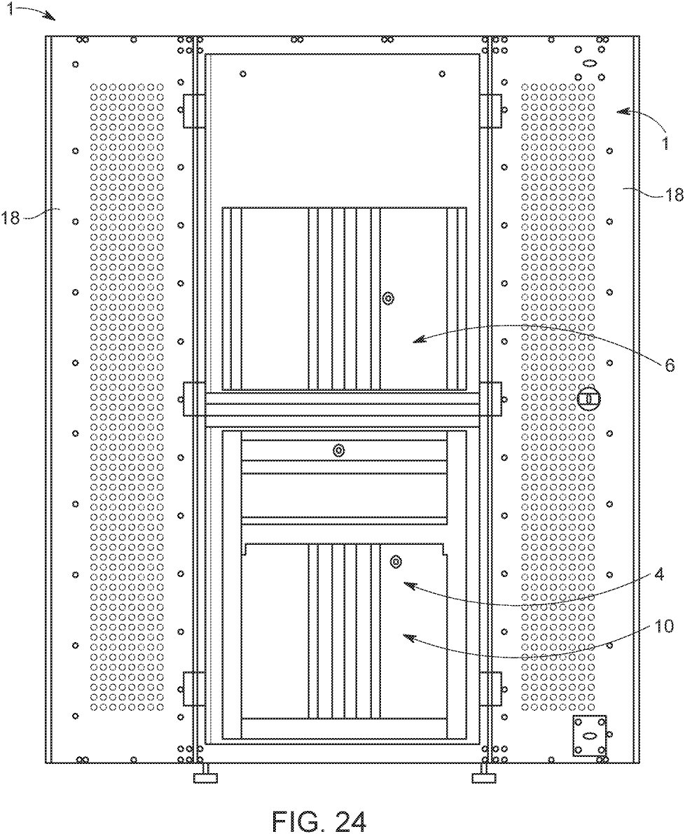

FIG. 24 illustrates the workbench system 1 in a second packaged arrangement. In this example, one medium cabinet 4 including a drawer cabinet 10 as described above, as well as one small cabinet 6, are able to be stored within the large cabinet 2. In one option, the drawer cabinet 10 and the small cabinet 6 can both be stored upright within the large cabinet 2. In another option, at least one of the drawer cabinet 10 or small cabinet 6 can be stored horizontally within the large cabinet 2.

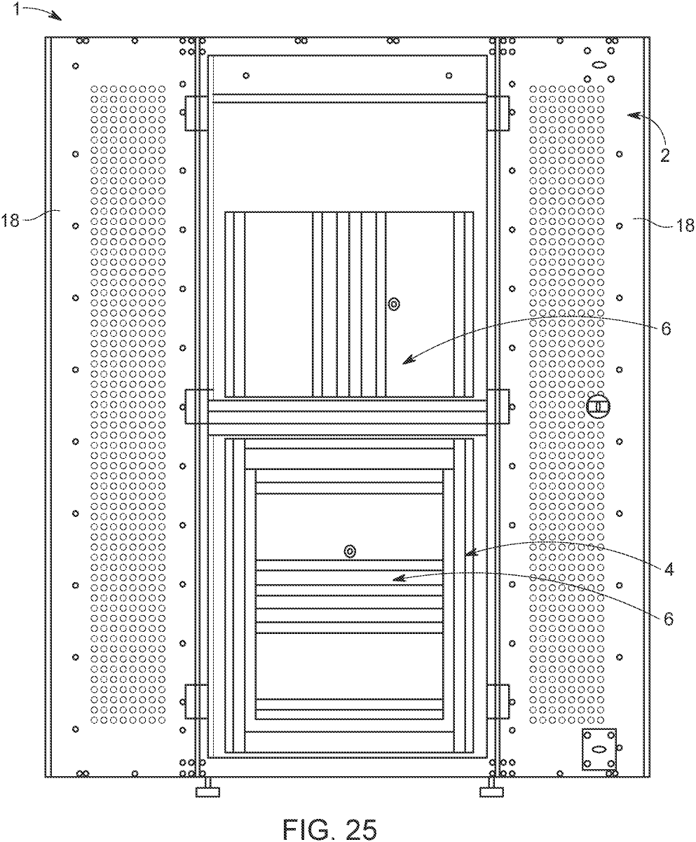

FIG. 25 illustrates the workbench system 1 in a third packaged arrangement. In this example, one medium cabinet 4 and two small cabinets 6 can be positioned within one large cabinet 2. More specifically, one of the small cabinets 6 can be positioned adjacent the medium cabinet 4, and another of the small cabinets 6 can be positioned within or nested inside the medium cabinet 4. In this manner, multiple or successive nesting arrangements can be utilized to store multiple cabinets within a larger cabinet for packaging.

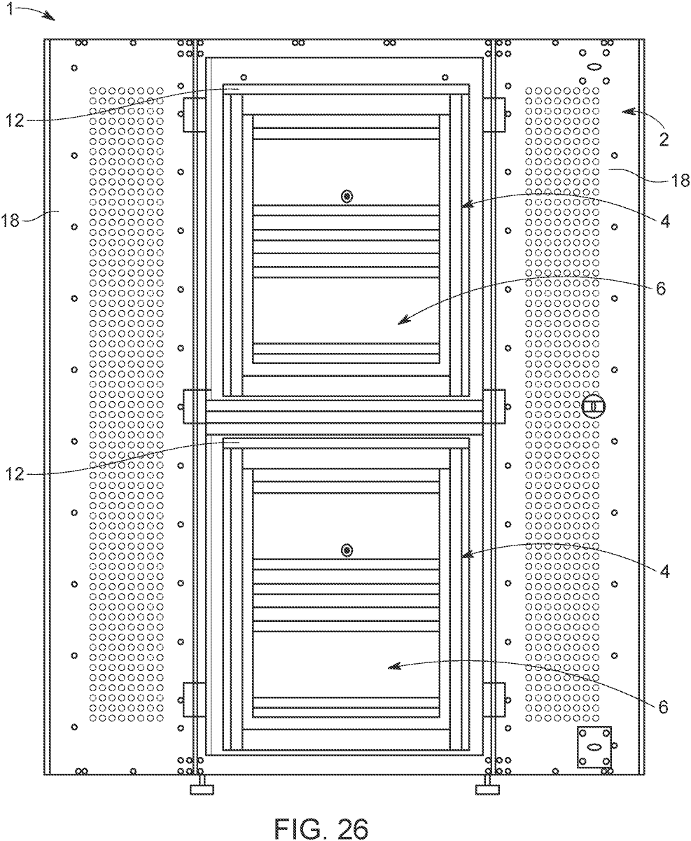

FIG. 26 illustrates the workbench system 1 in a fourth packaged arrangement. In this example, two medium cabinets 4, two small cabinets 6, and two worktops 12 can be positioned within one large cabinet 2. The two medium cabinets 4 can be positioned adjacent one another within the large cabinet 2. A small cabinet 6 can be positioned within each of the two medium cabinets 4. One worktop 12 can be positioned vertically above each of the two medium cabinets 4 as shown.

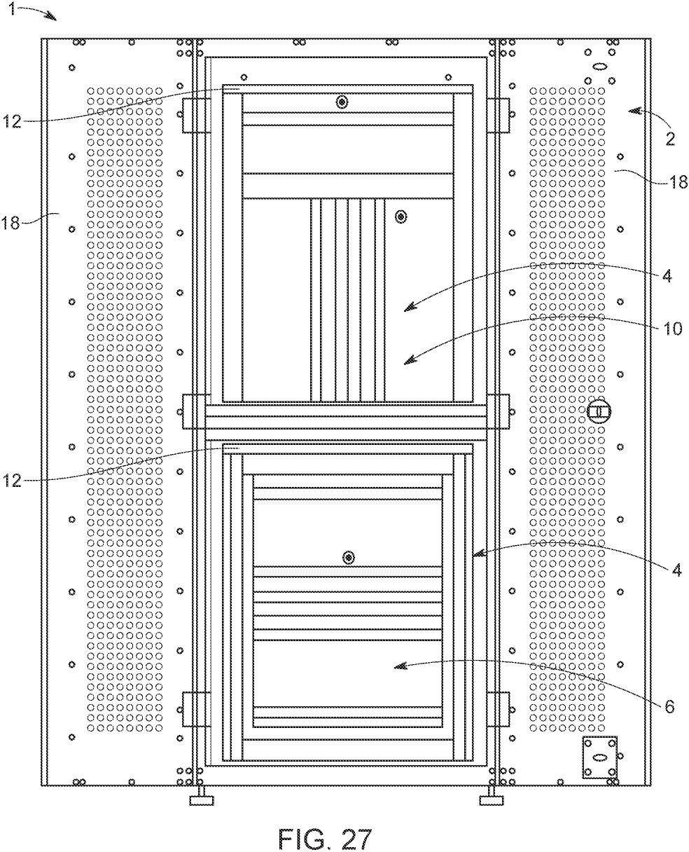

FIG. 27 illustrates the workbench system 1 in a fifth packaged arrangement. In this example, two medium cabinets 4, one small cabinet 6, and two worktops 12 can be positioned within one large cabinet 2. The two medium cabinets 4 can be positioned adjacent one another within the large cabinet 2. One of the two medium cabinets 4 can be in the form of a drawer cabinet 10 as described above. The other of the two medium cabinets 4 can house the small cabinet 6. One worktop 12 can be positioned vertically above each of the two medium cabinets 4 as shown.

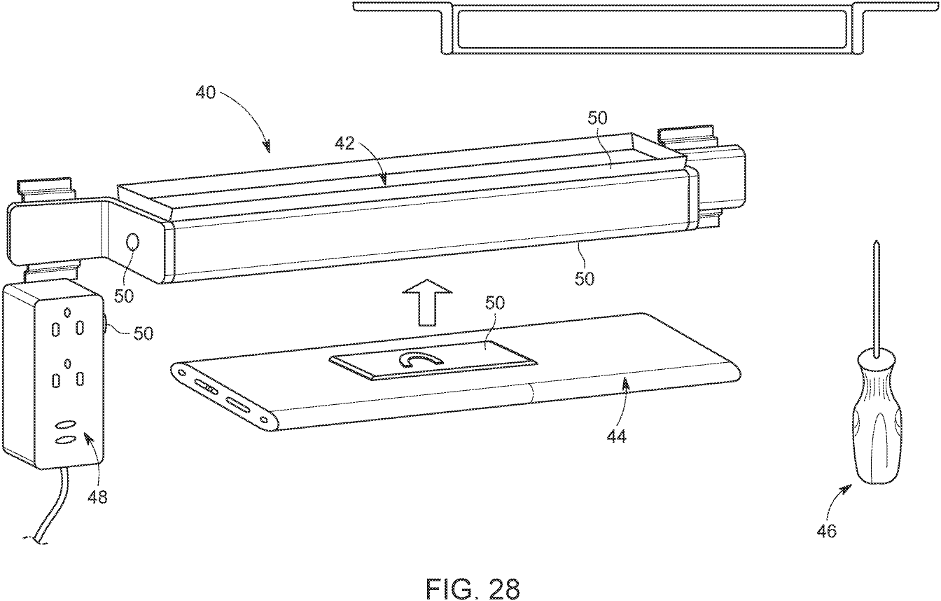

FIGS. 28-57 generally illustrate nonlimiting examples of modular accessory components that can be utilized in the modular workbench system of FIG. 1. Referring now to FIG. 28, one accessory component is shown in the form of a wall shelf 40 having end portions configured to couple or secure to a surface including, but not limited to, worktop 12, organization surface 14, or slat wall 16 (FIGS. 1-2). The wall shelf 40 can include a detachable coupling 50 on one or multiple sides of the wall shelf 40. As used herein, “detachable coupling” will refer to a mechanism configured to secure an item in a selectively removable manner. Such a “detachable coupling” can include, in non-limiting examples, a magnetic coupling, a keyhole coupling, a toggle coupling, a snap-fit coupling, a latch-and-catch coupling, or the like, or combinations thereof.

In the example shown, the detachable coupling 50 is in the form of magnet bars provided on top, bottom, and forward sides of the wall shelf 40. A tray 42 can detachably, e.g. magnetically or by gravity, couple to the top of the wall shelf 40. A light source 44 can detachably, e.g. magnetically, couple to the bottom of the wall shelf 40. The light source 44 can be in the form of a portable light source in one example. A tool 46 such as a screwdriver, wrench, or the like can detachably couple to the front of the wall shelf 40. Another detachable coupling 50 can be provided on a side surface of the wall shelf 40. In one example, a power supply 48 can include a recess configured to receive a hook provided on the side of the wall shelf 40, thereby forming the detachable coupling 50. In one example, the power supply 48 can be a portable power supply. In one example, the power supply 48 can include a magnetic portion for coupling to the side of the wall shelf 40, thereby forming a magnetic detachable coupling 50. In some examples, the power supply 48 can include an electrical connection or coupling within or through the wall shelf 40.

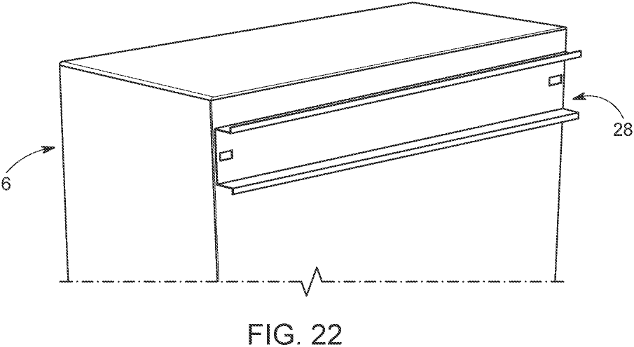

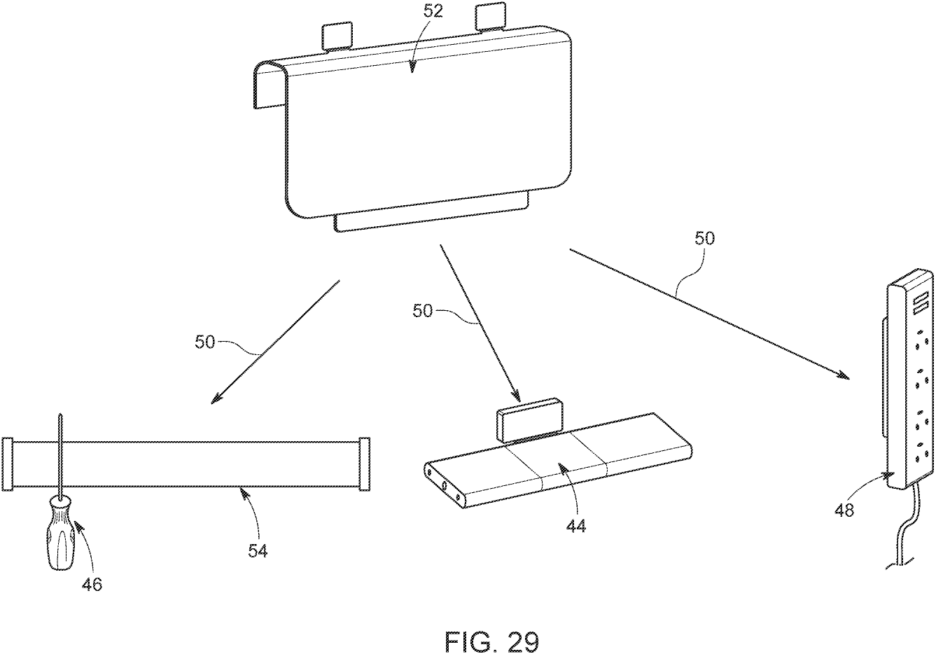

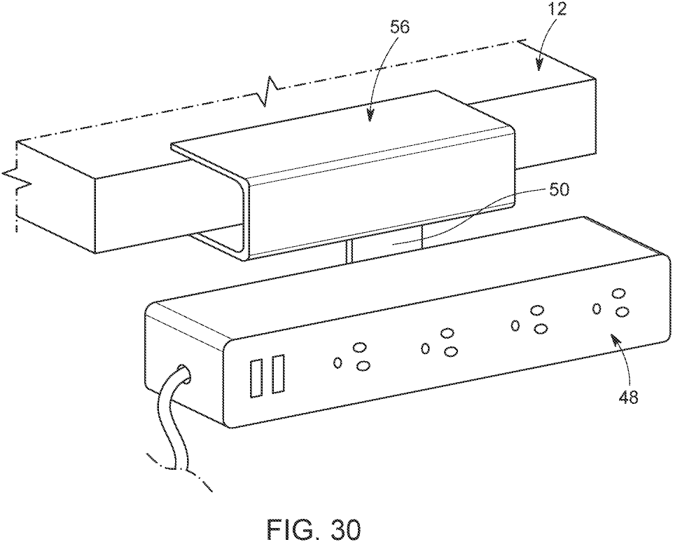

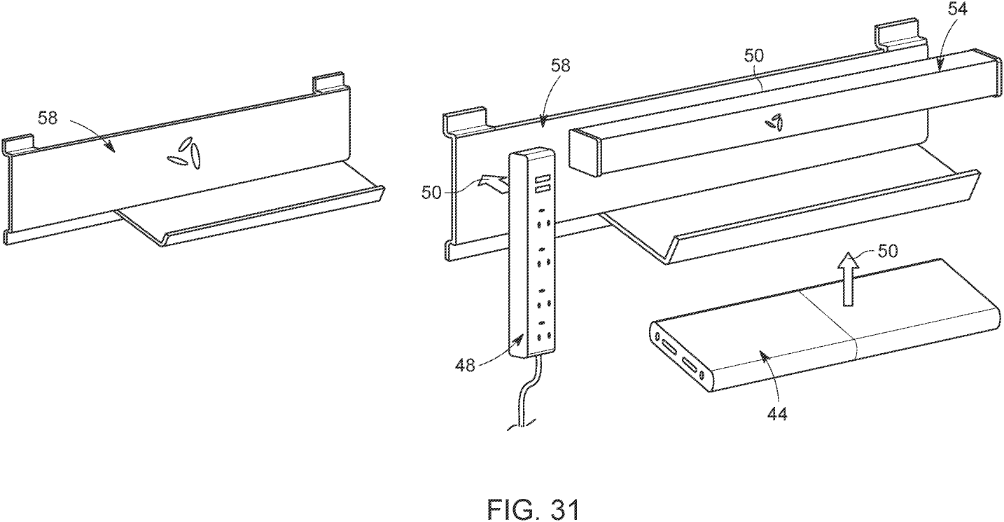

FIG. 29 illustrates an exemplary bracket 52 configured to couple or secure to a surface including, but not limited to, worktop 12, organization surface 14, or slat wall 16 (FIGS. 1-2). The bracket 52 can be similar to the bracket 28 (FIG. 22) though this need not be the case. In one example, bracket 52 can be provided on end portions of a magnet bar 54 or on end portions of the wall shelf 40 (FIG. 30). The bracket 52 can also include a detachable coupling 50 configured to selectively secure items, tools, or the like to the bracket 52. For example, the bracket 52 can include a magnetic detachable coupling 50 for magnetically receiving light source 44, tool 46, or power supply 48.

FIG. 30 illustrates a clamp 56 configured to couple or secure to a surface including, but not limited to, worktop 12, organization surface 14, or slat wall 16 (FIGS. 1 & 2). In the example shown the clamp 56 is configured to fit over an end of a work surface, such as along an edge of the worktop 12 (FIG. 1). Such a clamp 56 can include a detachable coupling 50, such as a magnetic coupling in one example. A tool or component such as power supply 48 can be selectively secured to the clamp 56 by way of the detachable coupling 50.

FIG. 31 illustrates a shelf bracket 58 configured to couple or secure to a surface including, but not limited to, worktop 12, organization surface 14, or slat wall 16 (FIGS. 1- 2). For example, the shelf bracket 58 can include bracket attachments for securing to the slat wall 16 or any organization surface 14 (FIG. 2). The shelf bracket 58 can include a detachable coupling 50. For example, the shelf bracket 58 can include a magnetic detachable coupling 50 for receiving light source 44, magnet bar 54, or power supply 48.

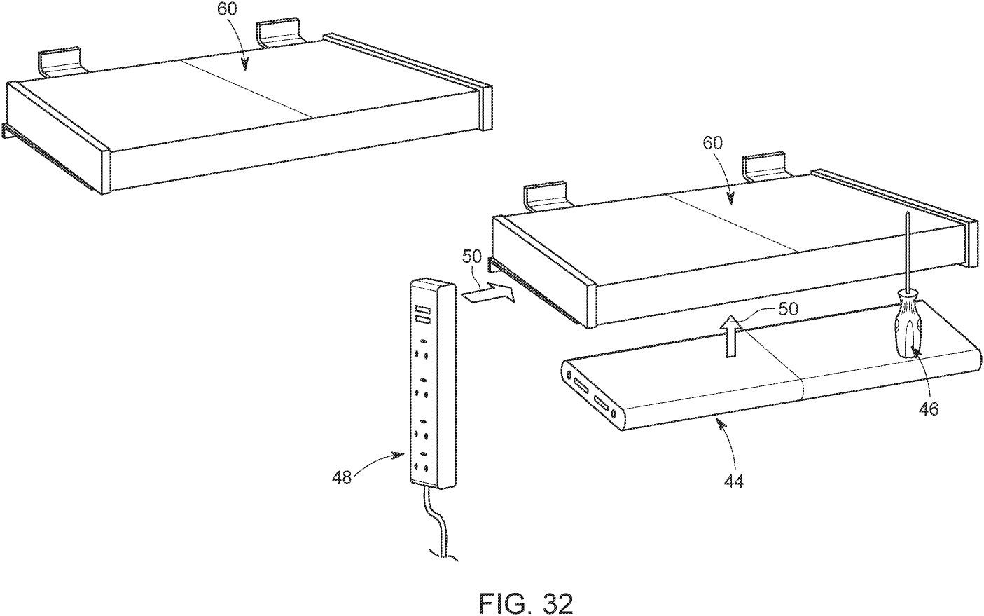

FIG. 32 illustrates a magnet bar shelf 60 configured to couple or secure to a surface including, but not limited to, worktop 12, organization surface 14, or slat wall 16 (FIGS. 1- 2). For example, the magnet bar shelf 60 can include brackets for securing to the slat wall 16 or any organization surface 14 (FIG. 2). The magnet bar shelf 60 can have an extended or projecting body and include a detachable coupling 50. For example, the magnet bar shelf 60 can include a magnetic detachable coupling 50 for receiving light source 44, tool 46, or power supply 48.

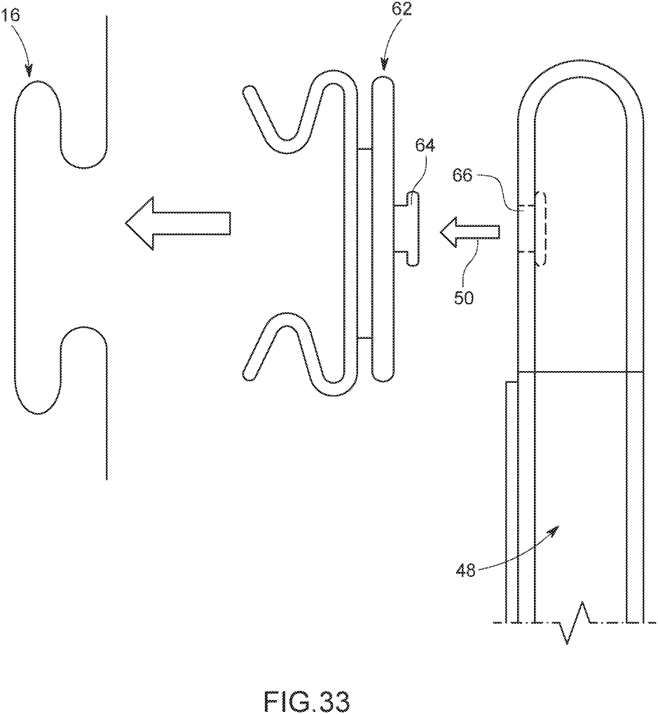

FIG. 33 illustrates a spring clip bracket 62 having legs configured to elastically retain the bracket 62 on a surface including, but not limited to, worktop 12, organization surface 14, or slat wall 16 (FIGS. 1- 2). The spring clip bracket 62 can include a detachable coupling 50. In the example shown, the detachable coupling 50 includes a projection member 64 configured to be received in a recess or aperture 66 located on an accessory, such as power supply 48. Such a projection member and recess or aperture can form a snap-fit connection, a button-catch connection, or a key-and-keyhole connection, in non-limiting examples.

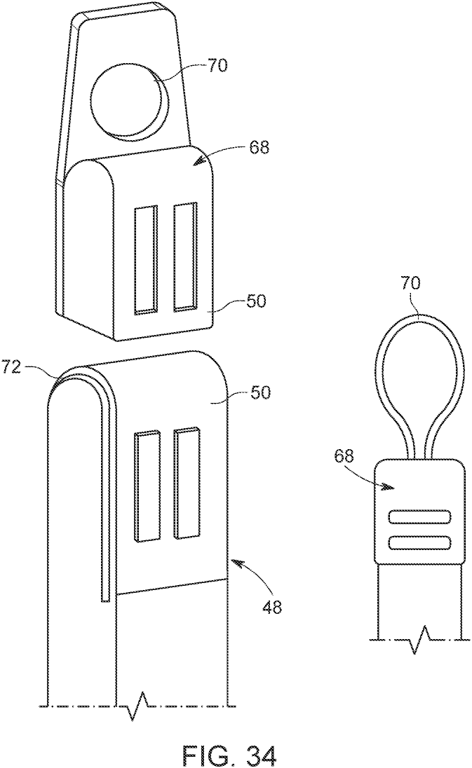

FIG. 34 illustrates a cover 68 configured to fit over an end of an accessory, such as power supply 48. In one example, the cover 68 also includes an aperture 70, such as a hole for hanging the accessory from a hook coupled to an exterior surface of the modular workbench system 1 including, but not limited to, worktop 12, organization surface 14, or slat wall 16 (FIGS. 1- 2). In one example, the aperture 70 can be formed in a base plate or flat portion extending from the cover 68. In another example, the aperture 70 can be formed in a loop extending from the cover 68. The cover 68 includes a detachable coupling 50. The detachable coupling 50 can include internal features configured to slide over or attach to rails 72 provided on the accessory, such as power supply 48.

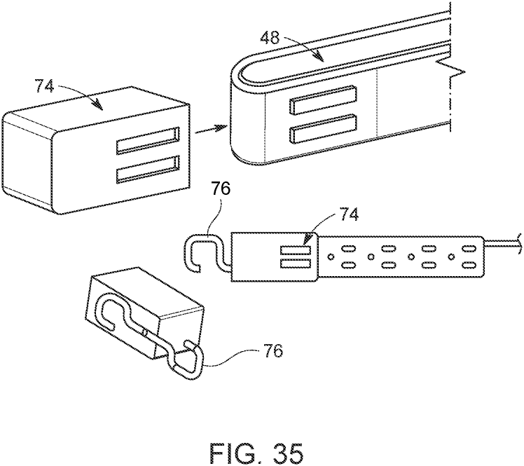

FIG. 35 illustrates another cover 74 configured to fit over an end of an accessory, such as power supply 48. The cover 74 can be similar to the cover 68. One difference compared to the cover 68 is that the cover 74 can include a pivoting or rotating attachment 76 that can be utilized to secure the accessory to a portion of the workbench system 1 including, but not limited to, worktop 12, organization surface 14, or slat wall 16 (FIGS. 1-2). In the example shown, the attachment 76 is in the form of a hook that can rotate outward to secure the cover 74 and accessory, e.g. power supply 48, to a portion of the workbench system 1, or rotate inward for storage. In another non-limiting example, the attachment 76 have a fixed or stationary hook.

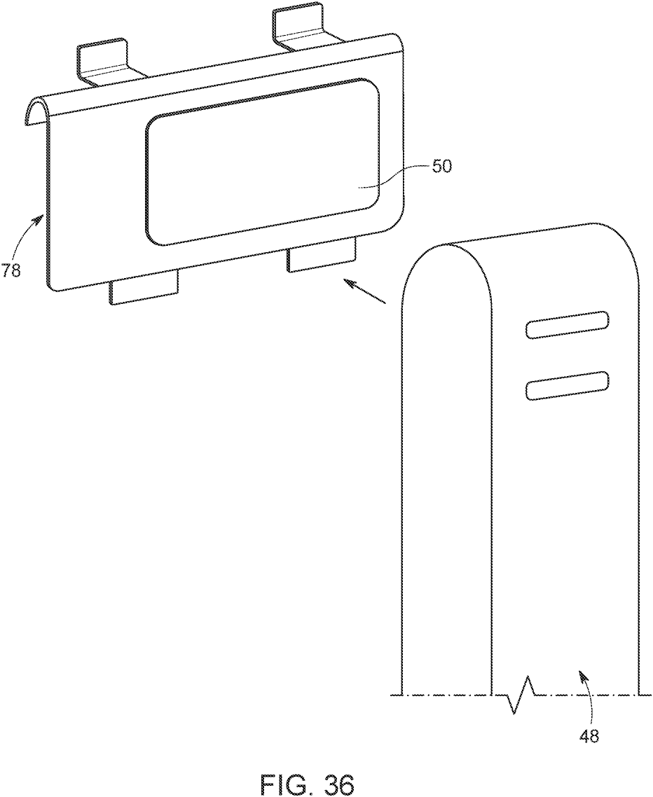

FIG. 36 illustrates another bracket 78 configured to couple or secure to a surface including, but not limited to, worktop 12, organization surface 14, or slat wall 16 (FIGS. 1-2). The bracket 78 can be similar to the bracket 52 or shelf bracket 58. The bracket 78 can include a detachable coupling 50, such as a magnetic detachable coupling 50, for receiving an accessory component such as power supply 48. In the example shown, the bracket 78 includes a plate, such as a steel plate, forming the detachable coupling 50.

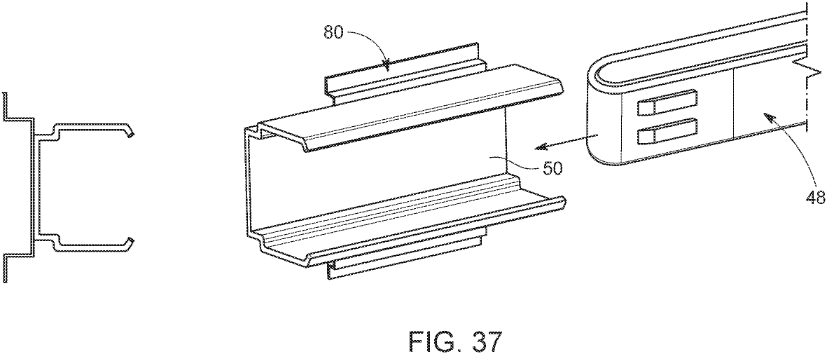

FIG. 37 illustrates a bracket sleeve 80 configured to couple or secure to a surface including, but not limited to, worktop 12, organization surface 14, or slat wall 16 (FIGS. 1-2). The bracket sleeve 80 can include a detachable coupling 50. In the example shown, the detachable coupling 50 is in the form of a sleeve configured to slidably receive an accessory component, such as power supply 48.

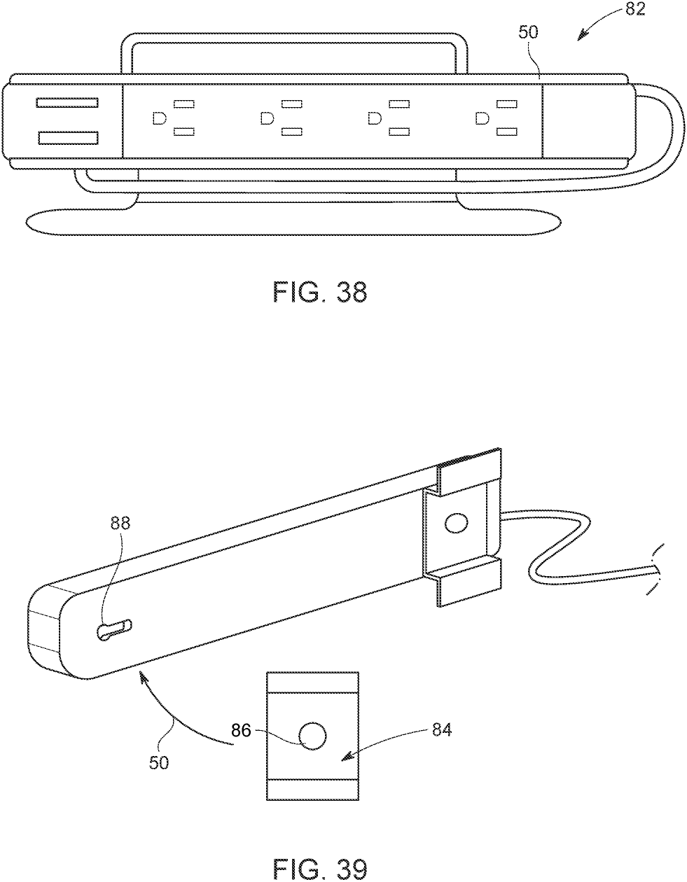

FIG. 38 illustrates another bracket sleeve 82 configured to couple or secure to a surface including, but not limited to, worktop 12, organization surface 14, or slat wall 16 (FIGS. 1-2). The bracket sleeve 82 can be similar to the bracket sleeve 80. The bracket sleeve 82 can include a detachable coupling 50. In the example shown, the detachable coupling 50 is in the form of a sleeve configured to slidably receive an accessory component, such as power supply 48. One difference compared to the bracket sleeve 80 is that the bracket sleeve 82 can be configured to extend along an entire length of the accessory component e.g. power supply 48. Another difference is that the bracket sleeve 82 can include a handle for carrying the accessory component. Another difference is that the bracket sleeve 82 can include a cable support for receiving a cord or cable attached to the accessory component, e.g. for cable management purposes.

FIG. 39 illustrates bracket attachments 84 configured to couple or secure to a surface including, but not limited to, worktop 12, organization surface 14, or slat wall 16 (FIGS. 1-2). The bracket attachments 84 can include a detachable coupling 50. In the example shown, the detachable coupling 50 is in the form of a keyhole projection 86 and recess 88. In one example the keyhole projection 86 can be provided on the bracket attachment 84, and the recess 88 can be provided on an accessory component, such as magnet bar 54.

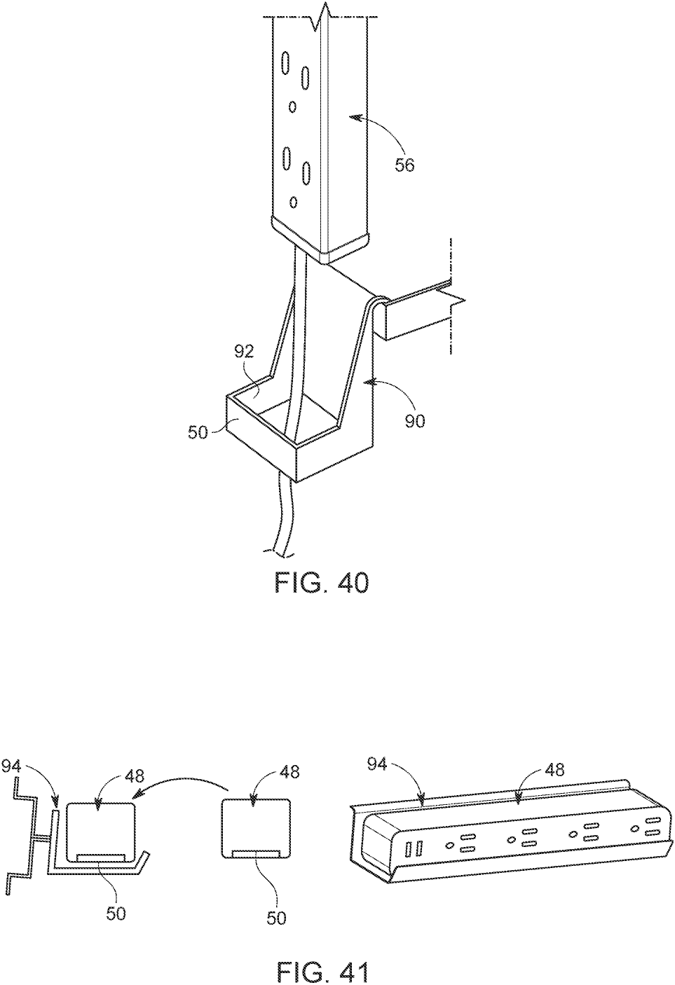

FIG. 40 illustrates a cap 90 configured to couple or secure to a surface including, but not limited to, worktop 12, organization surface 14, or slat wall 16 (FIGS. 1-2). In the example shown the cap 90 is configured to fit over an end of a work surface, such as along an edge of the worktop 12 (FIG. 1). Such a cap 90 can include a detachable coupling 50. In the example shown, the detachable coupling 50 can include an integral sleeve 92. Additionally, or alternatively, the sleeve 92 can include a magnetic coupling. A tool or component such as power supply 48 can be selectively secured to the cap 90 by insertion into the sleeve 92.

FIG. 41 illustrates a shelf 94 configured to couple or secure to a surface including, but not limited to, worktop 12, organization surface 14, or slat wall 16 (FIGS. 1-2). The shelf 94 can include a detachable coupling 50 for securing or carrying an accessory component, such as power supply 48. In the example shown, the detachable coupling 50 can be in the form of a magnetic attachment provided on or within either or both of the accessory component (e.g. power supply 48) or shelf 94. In one example the shelf 94 can include bracket attachments or legs for securing to a surface.

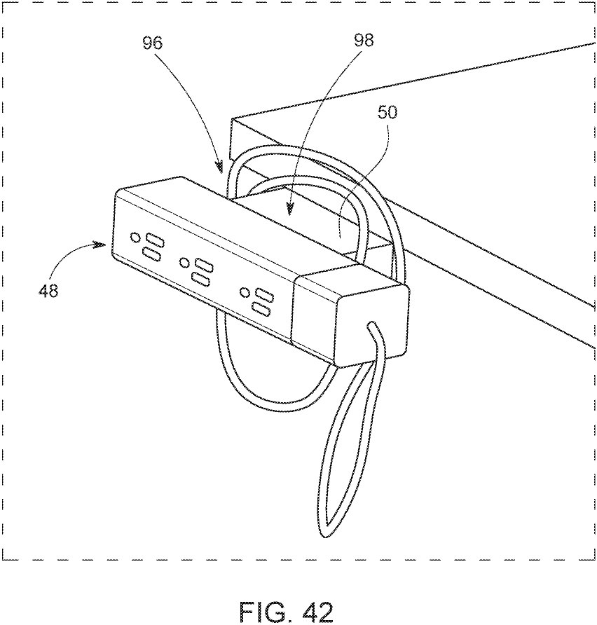

FIG. 42 illustrates a mount 96 configured to couple or secure to a surface including, but not limited to, worktop 12, organization surface 14, or slat wall 16 (FIGS. 1-2). The mount 96 can include a detachable coupling 50 for securing or carrying an accessory component, such as power supply 48. In the example shown, the detachable coupling 50 can be in the form of a magnetic attachment provided on or within either or both of the accessory component (e.g. power supply 48) or mount 96. The mount 96 can be configured to extend from a surface edge (e.g. from worktop 12) for holding the accessory component. The mount 96 can also include a portion 98 configured to provide for cable management, such as a power cable extending from power supply 48. The portion 98 can be provided in the center of the mount 96, or at one end of the mount 96, in non-limiting examples.

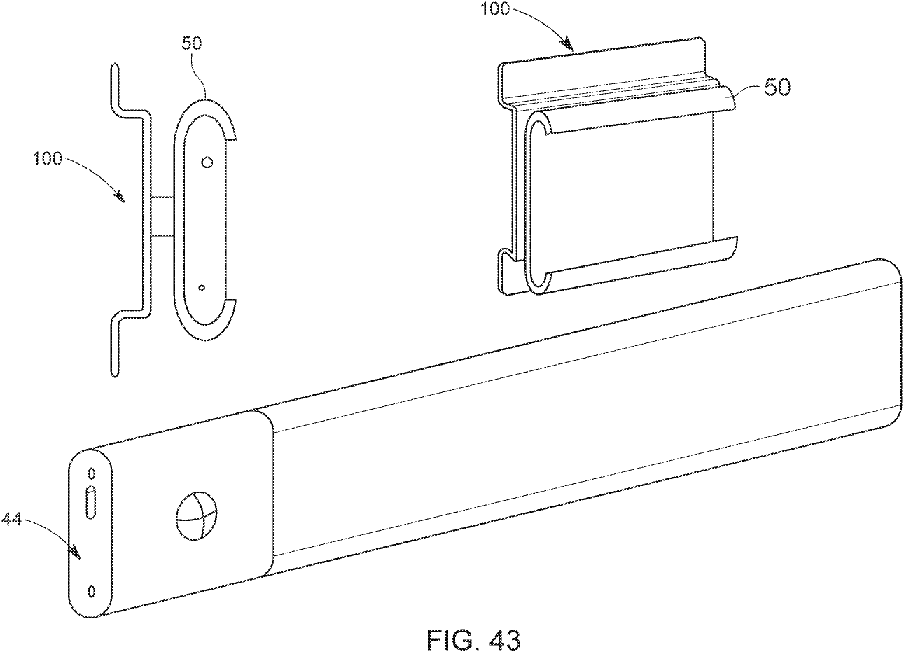

FIG. 43 illustrates a spring-clip bracket 100 configured to couple or secure to a surface including, but not limited to, worktop 12, organization surface 14, or slat wall 16 (FIGS. 1-2). The spring-clip bracket 100 can include a detachable coupling 50. In the example shown, the detachable coupling 50 includes a spring-clip sleeve or edge portions configured to receive an accessory component, such as light source 44.

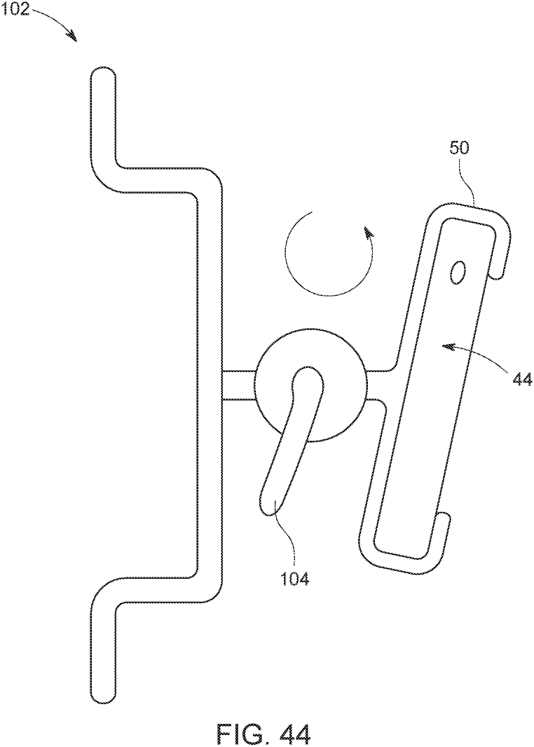

FIG. 44 illustrates another spring-clip bracket 102 configured to couple or secure to a surface including, but not limited to, worktop 12, organization surface 14, or slat wall 16 (FIGS. 1-2). The spring-clip bracket 102 can include a detachable coupling 50. In the example shown, the detachable coupling 50 includes a spring-clip sleeve or edge portions configured to receive an accessory component, such as light source 44. The spring-clip bracket 102 can be similar to the spring-clip bracket 100. One difference is that the spring-clip bracket 102 can include a pivoting coupling 104. In one non-limiting example the pivoting coupling 104 can be a tension knob or screw providing repositioning of an accessory component within the detachable coupling 50.

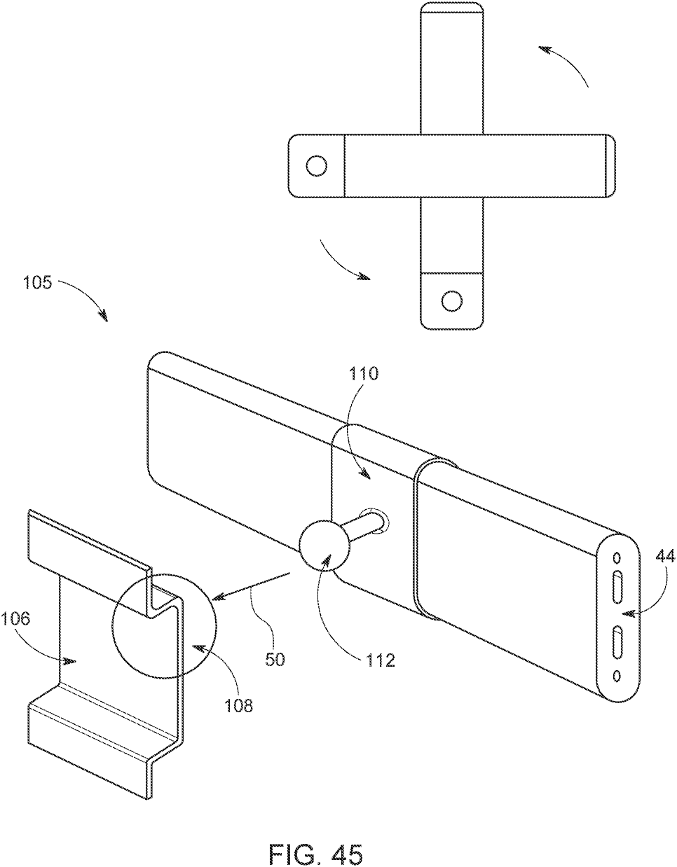

FIG. 45 illustrates a two-piece bracket 105 configured to couple or secure to a surface including, but not limited to, worktop 12, organization surface 14, or slat wall 16 (FIGS. 1-2). The two-piece bracket 105 can include a detachable coupling 50. In the example shown, the detachable coupling 50 includes a bracket base 106 having a recess 108, and a sleeve 110 having a ball joint 112. The sleeve 110 can be configured to receive an accessory component, such as light source 44. In this manner the recess 108 and ball joint 112 can provide for rotation, tilting, or re-positioning of the accessory component while mounted to the two-piece bracket 105.

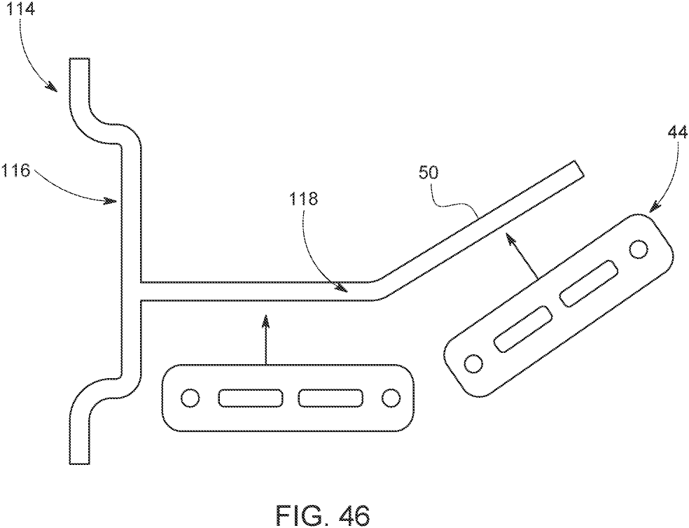

FIG. 46 illustrates another bracket 114 configured to couple or secure to a surface including, but not limited to, worktop 12, organization surface 14, or slat wall 16 (FIGS. 1-2). The bracket 114 can include a detachable coupling 50. In the example shown, the detachable coupling 50 includes a magnetic coupling configured to receive an accessory component, such as light source 44. The bracket 114 can include a bracket base 116 with projecting arm 118 configured to bend, rotate, or move to form multiple angles with respect to the bracket base 116. In some examples, the projecting arm 118 can be formed of a bendable material that can be formed or retained in a customized shape. In some examples, the projecting arm 118 can including rotatable or pivoting portions that can form multiple angled positions with respect to bracket base 116. In some examples, a locking feature such as a fastening screw or tension latch can be provided for securing a position or orientation of the projecting arm 118. In this manner the bracket 114 can provide for rotation, tilting, or re-positioning of the accessory component while mounted to the bracket 114.

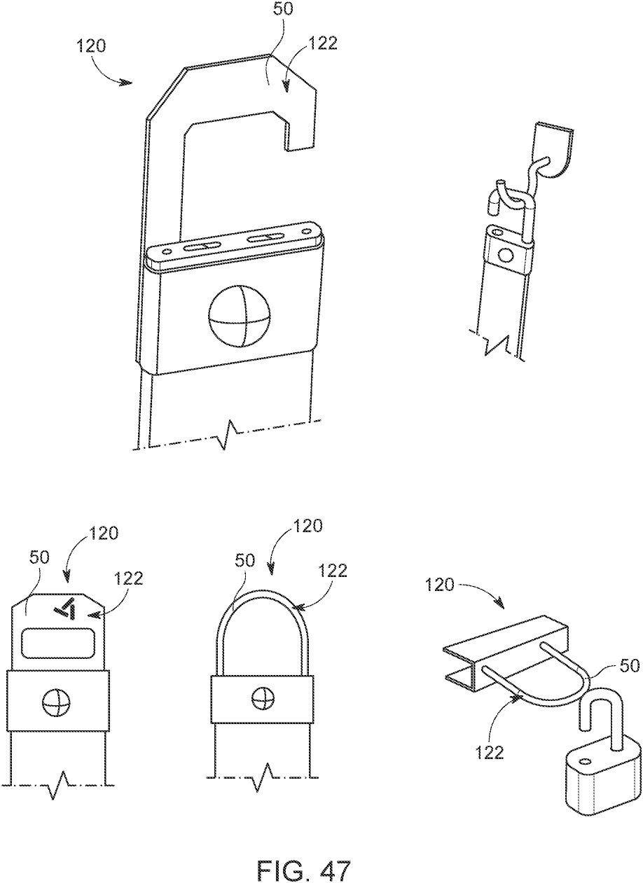

FIG. 47 illustrates exemplary caps 120 configured to fit over an end of an accessory, such as light source 44, or over an end or edge of a surface including, but not limited to, worktop 12, organization surface 14, or slat wall 16 (FIGS. 1-2). The caps 120 can be secured to corresponding accessory components via a screw, or by press-fitting or tension, in non-limiting examples. The caps 120 can include detachable couplings 50. Some exemplary detachable couplings 50 can include a hooked portion 122 such as a J-hook, an aperture, a looped wire, or the like.

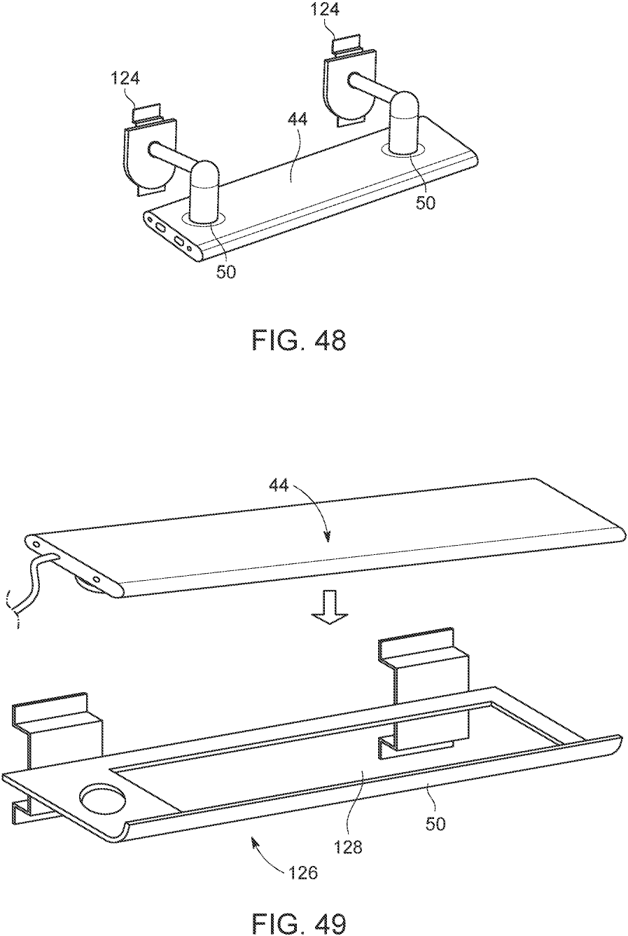

FIG. 48 illustrates a pair of brackets 124 configured to couple or secure to a surface including, but not limited to, worktop 12, organization surface 14, or slat wall 16 (FIGS. 1-2). The pair of brackets 124 can each include a detachable coupling 50. In the example shown, the detachable coupling 50 includes a magnetic coupling configured to receive an accessory component, such as light source 44. In the non-limiting example shown, the pair of brackets 124 can be used to form a detachable drop lighting arrangement for a workspace, where the light source 44 can be removed and replaced as needed. Additionally or alternatively, a magnetic member can also be provided on or within the accessory component (e.g. light source 44) for coupling to the pair of brackets 124.

FIG. 49 illustrates a frame 126 configured to couple or secure to a surface including, but not limited to, worktop 12, organization surface 14, or slat wall 16 (FIGS. 1-2). For example, the frame 126 can include brackets or legs configured to couple or secure to a surface. The frame 126 can include a detachable coupling 50. In the example shown, the detachable coupling 50 includes an aperture 128 configured to receive an accessory component, such as light source 44. In the non-limiting example shown, the frame 126 can be used to form a detachable drop lighting arrangement for a workspace, where the light source 44 can be removed and replaced as needed. Additionally, or alternatively, a magnetic member can also be provided on or within the accessory component (e.g. light source 44) for coupling to the frame 126.

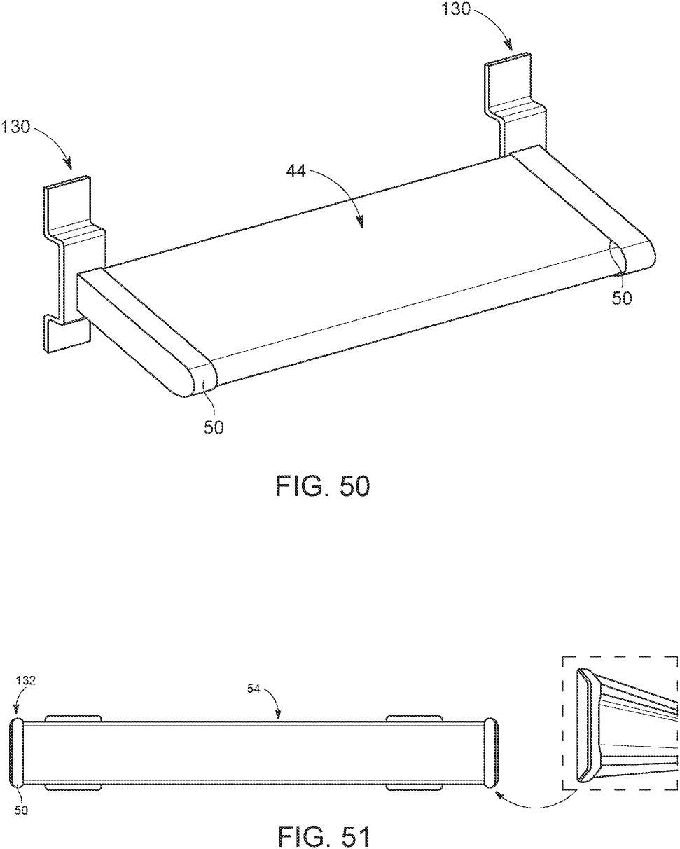

FIG. 50 illustrates a pair of endcaps 130 configured to couple or secure to a surface including, but not limited to, worktop 12, organization surface 14, or slat wall 16 (FIGS. 1-2). For example, the endcaps 130 can include brackets or legs configured to couple or secure to a surface. The endcaps 130 can include a detachable coupling 50. In the example shown, the detachable coupling 50 includes a cap fitting configured to receive an accessory component, such as light source 44. In the non-limiting example shown, the endcaps 130 can be used to form a detachable drop lighting arrangement for a workspace, where the light source 44 can be removed and replaced as needed. Additionally, or alternatively, a magnetic member can also be provided on or within the accessory component (e.g., light source 44) for coupling to the endcaps 130.

FIG. 51 illustrates another pair of endcaps 132 configured to couple or secure to a surface including, but not limited to, worktop 12, organization surface 14, or slat wall 16 (FIGS. 1-2). For example, the endcaps 132 can include brackets or legs configured to couple or secure to a surface. The endcaps 132 can also include a detachable coupling 50. In the example shown, the detachable coupling 50 includes a cap fitting configured to receive an accessory component, such as magnet bar 54. The endcaps 132 can be similar to the endcaps 130. One difference compared to the endcaps 130 is that the endcaps 132 can include cap fittings that are offset from bracket legs, thereby providing a more central attachment for the coupled accessory component. In the non-limiting example shown, the endcaps 130 can be used to form a detachable magnet bar arrangement for a workspace, where the magnet bar 54 can be removed and replaced as needed.

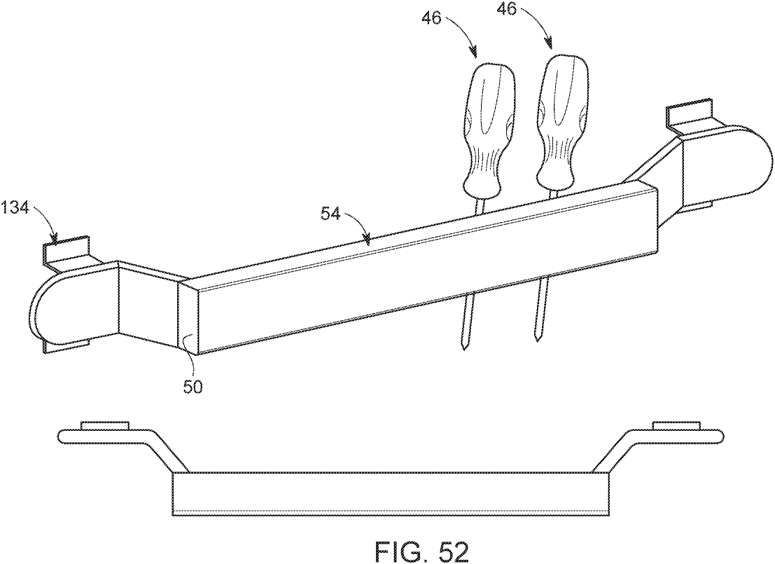

FIG. 52 illustrates a pair of offset endcaps 134 configured to couple or secure to a surface including, but not limited to, worktop 12, organization surface 14, or slat wall 16 (FIGS. 1-2). For example, the offset endcaps 134 can include brackets or legs configured to couple or secure to a surface. The offset endcaps 134 can also include a detachable coupling 50. In the example shown, the detachable coupling 50 includes a cap fitting configured to receive an accessory component, such as magnet bar 54. The offset endcaps 134 can be similar to the endcaps 130. One difference compared to the endcaps 130 is that the offset endcaps 134 can include a projecting portion that forms a gap between the coupled accessory component and the surface (e.g. slat wall 16). In the non-limiting example shown, the offset endcaps 134 can be used to form a detachable, double-sided magnet bar arrangement for a workspace, where the magnet bar 54 can be removed and replaced as needed, and where tools (e.g. tools 46) can be stored behind the magnet bar 54 as well as on an outer surface of magnet bar 54.

FIG. 53 illustrates a tray 136 that can be utilized with the offset endcaps 134. The tray 136 can be inserted into the space formed behind the offset endcaps 134. Additionally, or alternatively, a magnetic coupling can be provided between the tray 136 and offset endcaps 134.

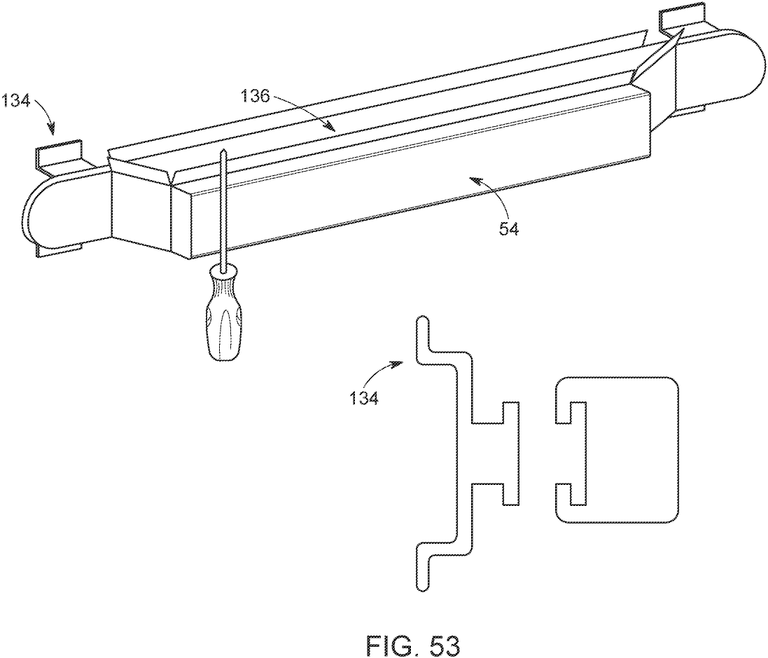

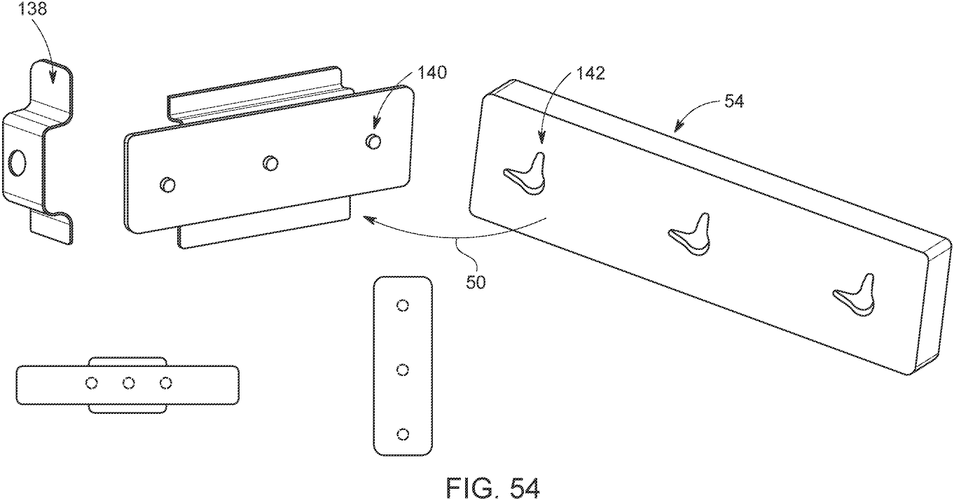

FIG. 54 illustrates a bracket 138 configured to couple or secure to a surface including, but not limited to, worktop 12, organization surface 14, or slat wall 16 (FIGS. 1-2). The bracket 138 can include a detachable coupling 50. In the example shown, the detachable coupling 50 includes a two-way keyhole coupling configured to receive an accessory component, such as magnet bar 54. For example, the bracket 138 can include a projection 140 configured to fit into a two-way recess 142 provided in the accessory component, such as for horizontal mounting or for vertical mounting. In this manner a given accessory component can be removably secured or mounted to the bracket 138 in multiple orientations.

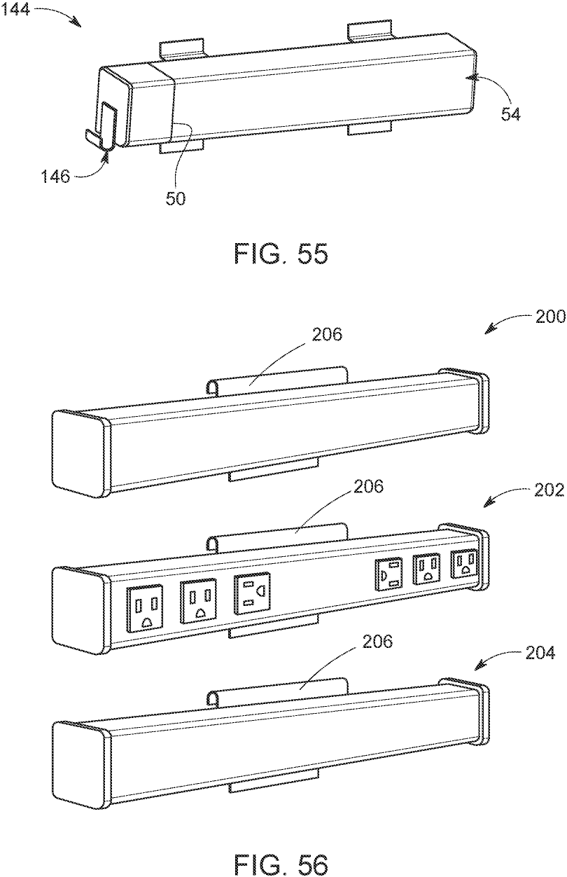

FIG. 55 illustrates a cap sleeve 144 configured to couple or secure to a surface including, but not limited to, worktop 12, organization surface 14, or slat wall 16 (FIGS. 1-2). For example, the cap sleeve 144 can include brackets, legs, or other components for securing to a surface. The cap sleeve 144 can also include a detachable coupling 50. In the example shown, the detachable coupling 50 includes a sleeve housing configured to receive an accessory component, such as magnet bar 54. In one example, the cap sleeve 144 can include a hook 146 at one end, such as for hanging a power supply or other accessory component.

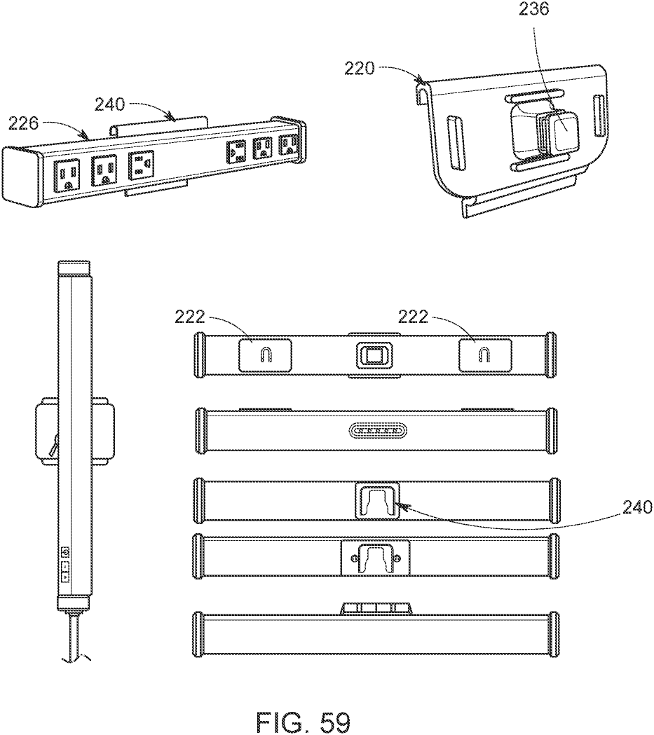

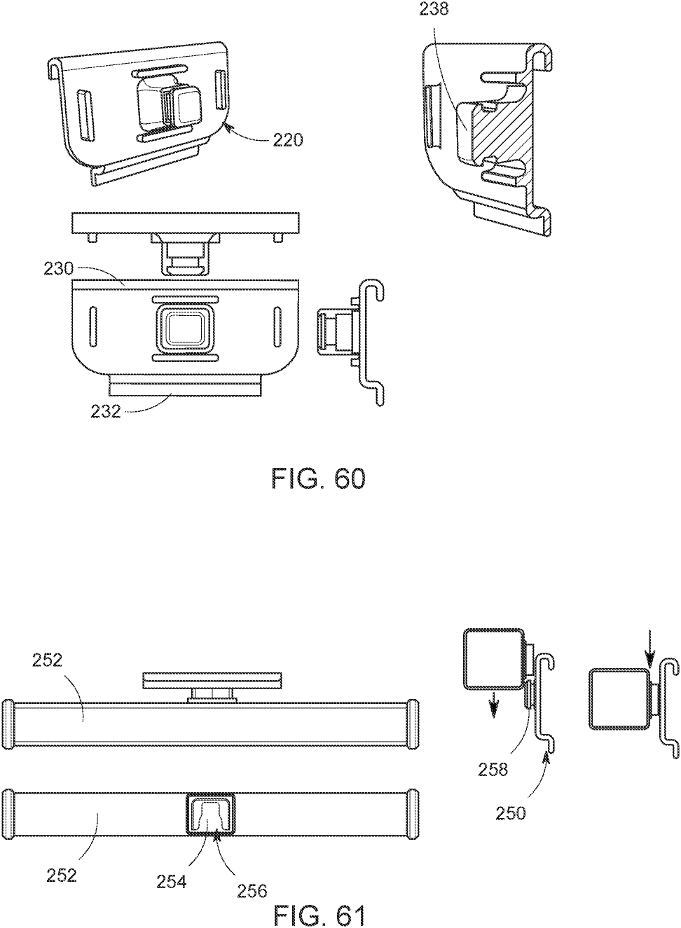

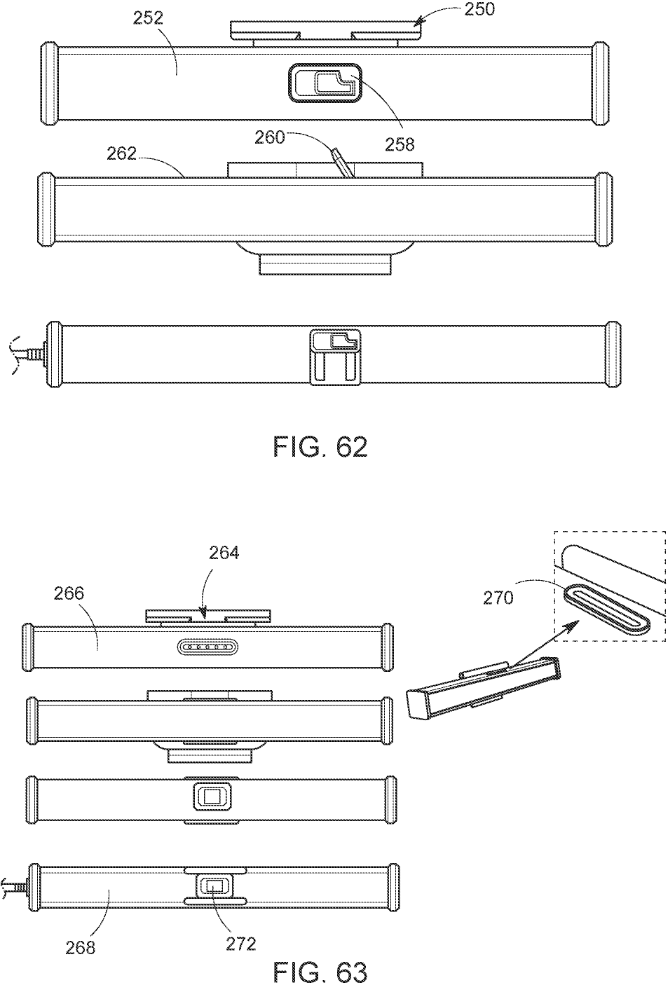

With general reference to FIGS. 56-67, some exemplary implementations of the workbench system 1 are shown including cabinets (FIGS. 1-27), modular accessory components (FIGS. 28-55), and other described aspects of the present disclosure. It will be understood that such implementations are provided for illustrative purposes only and do not limit the disclosure in any way.

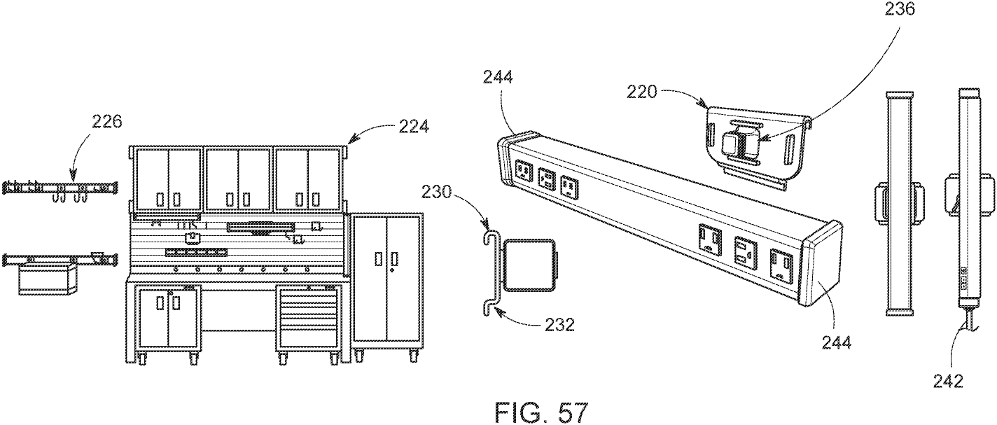

FIGS. 56-57 illustrates three exemplary implementations of modular accessory components including a magnet bar 200 similar to the magnet bar 54 (FIG. 29), a power supply 202 similar to the power supply 48 (FIG. 28) and in the form of a power strip, and a light source 204 similar to the light source 44 (FIG. 28) and in the form of a light bar. A mounting bracket 206 can be provided for securing to rails or other portions of an organization surface. In one exemplary implementation, light bars can be magnetically coupled to metal cabinet sides or bottom walls as well as to a rail or slat wall in some examples. In other implementations, magnet bars and power strips can also be magnetically coupled to metal cabinet sides or bottom walls as well as to a rail or slat walls.

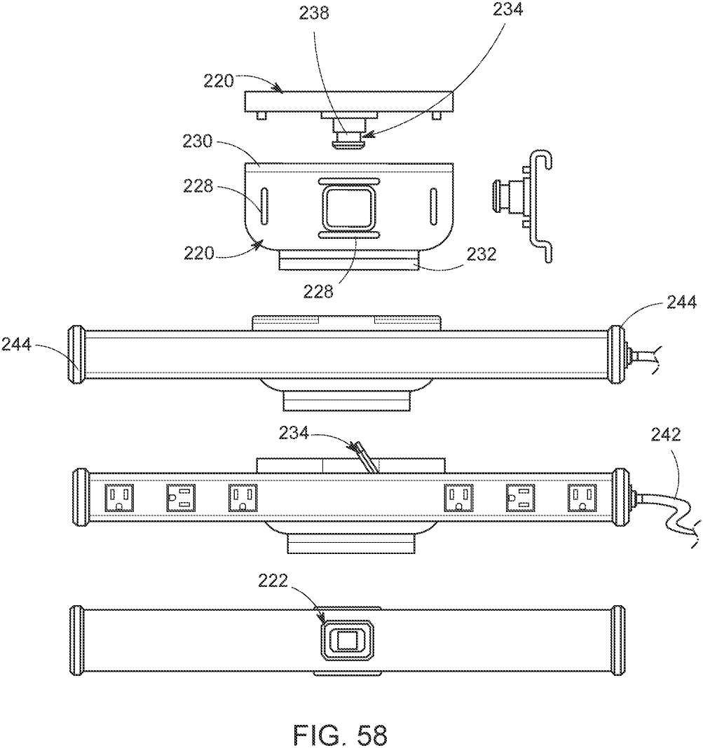

FIGS. 58-60 illustrates that a universal mounting bracket 220 and backside magnets 222 can be provided for coupling to multiple components, such as a cabinet 224 or a modular accessory component 226 e.g., light bar, power strip, magnet bar, or the like. The described aspects of the universal mounting bracket 220 can have applicability to any of the accessory components described in FIGS. 28-55 including, but not limited to, bracket 28 (FIG. 22), bracket 52 (FIG. 29), shelf bracket 58 (FIG. 31), spring clip bracket 62 (FIG. 33), bracket 78 (FIG. 36), bracket sleeve 80 (FIG. 37), bracket sleeve 82 (FIG. 38), bracket attachment 84 (FIG. 39), spring-clip bracket 100 (FIG. 43), spring-clip bracket 102 (FIG. 44), two-piece bracket 105 (FIG. 45), bracket 114 (FIG. 46), pair of brackets 124 (FIG. 48), or bracket 138 (FIG. 54).

Resting pads 228 can be provided at top and bottom surfaces 230, 232 as well as either end of the universal mounting bracket 220. In some examples, a latch locking mechanism 234 can be provided for securing an accessory component 226 to the universal mounting bracket 220. In some examples, a push button locking mechanism 236 can be provided for securing an accessory component 226 to the universal mounting bracket 220. In some examples, a friction fit locking mechanism 236 can be provided for securing an accessory component to the universal mounting bracket 220. The universal mounting bracket 220 can also include a chamfered post 238 for slotting into a rail, slat wall, aperture, or the like. End caps 244 can also be provided as a separate or integrated component with the modular accessory component 226. In some examples, a power cord 242 can be integrated with an end cap 244. Additionally, or alternatively, the end cap 244 can be a separate component with an aperture through which a power cord 242 can be inserted. The end caps 244 can provide an outside envelope and form an outermost extent of the modular accessory component 226 such that no portion of the component extends beyond the end cap 244. The end caps 244 can also provide for bumper-style shock absorption, and can be rubberized in some examples. It is also contemplated that the end caps 244 can be magnetized.

A universal mounting bracket fitting 240 can be provided in the back of the modular accessory components 226, e.g., light bar, power strip, or magnet bar. The modular accessory components 226 can be positioned in multiple orientations in the universal mounting bracket 220, including two horizontal and two vertical positions in a non-limiting example. The backside magnets 222 can attach to other metallic components, such as cabinets or workbenches, and can also be positioned within in bumpers, slots, end caps, or the like.

In some examples, the magnet bar, power supply, and light source can have identical sizes, such as 3-4 cm × 3-4 cm × 40-50 cm in a non-limiting example. In addition, the magnet bar, power supply, and light source can be configured for one-handed operation for securing and releasing from the universal mounting bracket 220. In this manner a user’s hand can easily fit about the modular accessory components 226 for easy, secure grasp of the accessory component 226.

FIGS. 61-63 illustrate some examples for holding a universal mounting bracket 250 securely to modular accessory components 252. In some examples, backside friction can be utilized to hold the bracket 250 in place with a predetermined applied force for coupling or removing accessory components from the universal mounting bracket 250. Resting pads 254 can be provided to improve the quality of the fit, e.g., preventing wobble, rocking, vibration, or the like of a part coupled to the bracket 250. In some examples, the accessory component 252 can include an angled aperture 256 configured to slide onto a square slotted post on the universal mounting bracket 250 and form an interference fit once seated. In some examples, the accessory component 252 can include a rotatable cam action latch 260 to hold the accessory component 252 in place. Such a rotatable latch 260 can be positioned on an exterior surface 262 of the accessory component 252 or within a recessed space 264 of the accessory component, including a space sized to accommodate a user’s finger for rotating the latch 260. In some examples, the accessory component 252 can include a spring-operated push button 270 on at least one surface for releasably engaging the universal mounting bracket 250, including a top surface 266, a back surface 268, or a pair of spaced surfaces (e.g. dual push button operation), or the like. In some examples, the accessory component 252 can include a square receiver 272 or aperture configured to fit over the post 258 on the universal mounting bracket 250.

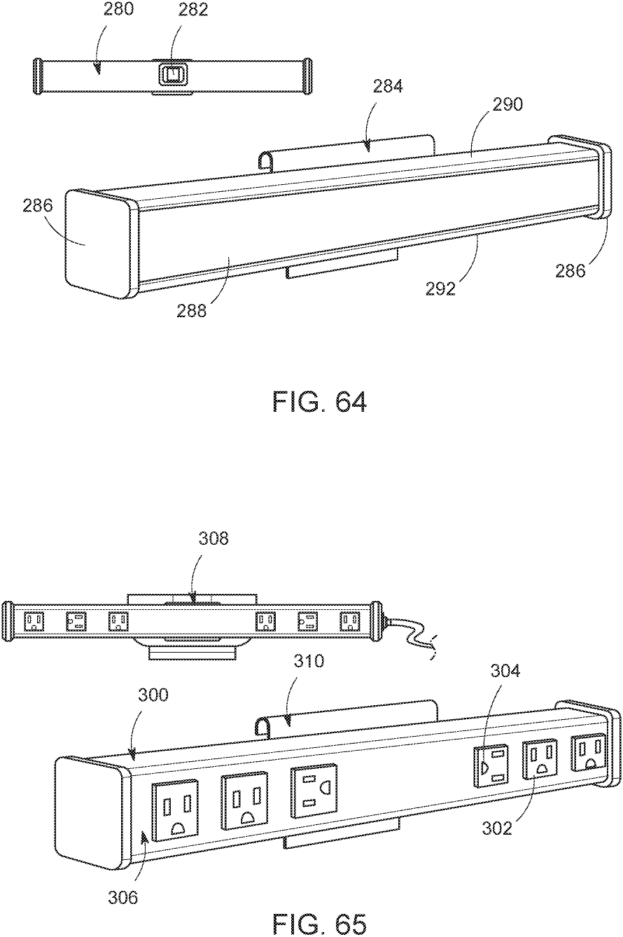

FIG. 64 illustrates an exemplary implementation for a magnet bar 280 similar to the magnet bar 54 (FIG. 29). The magnet bar 280 can include a square push-button receiver 282 for coupling to a universal mounting bracket 284. End caps 286 can be provided on opposing sides of the magnet bar 280, and a front face 288 of the magnet bar 280 can be smooth for receiving and holding metallic tools. The magnet bar 280 can include any suitable magnet including ceramic or neodymium in some examples. Top and bottom front-facing edges 290, 292 can be rounded or beveled to provide for ease in placing or removal of tools on the front face 288.

FIG. 65 illustrates an exemplary implementation for a power supply 300 similar to the power supply 48 (FIG. 28). The power supply 300 is illustrated with six outlets 302 although any number can be provided. Some of the outlets 302 can have differing orientations with respect to one another. In the non-limiting example shown, two outlets 302 near the center of the power supply 300 are oriented perpendicular to the remaining four outlets 302 and with corresponding ground slots 304 confronting one another. Such an arrangement can provide for improved access and accommodation of varying sizes of power bricks or the like. End gaps 306 can be provided at opposing ends of the power supply 300. The power supply 300 can also include a push-button receiver 308 for coupling to a universal mounting bracket 310, with push buttons provided on top and bottom surfaces in a squeeze-grip configuration.

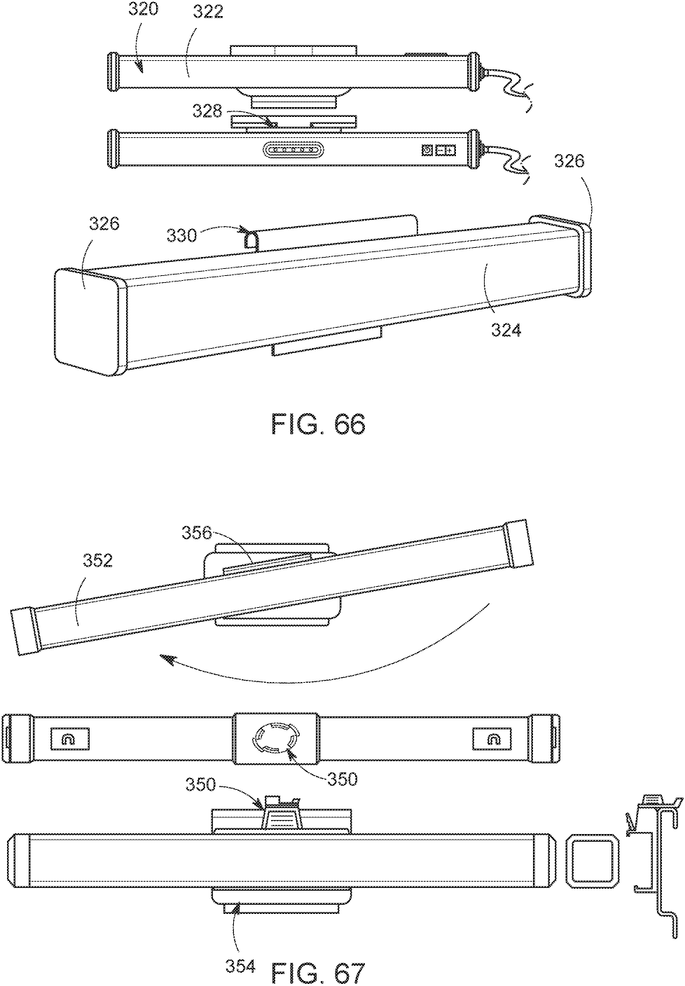

FIG. 66 illustrates an exemplary implementation for a light source 320 similar to the light source 44 (FIG. 28). The light source 320 can be in the form of a light bar 322 and include a diffuser 324 on at least one surface, such as a front panel or a bottom panel. Such a diffuser 324 can be configured to broadly illuminate a region proximate to the light bar 322 while also providing for a cool touch surface on the exterior of the light bar 322. End caps 326 can be provided at opposing ends of the light bar 322. The light bar 322 can also include a push-button receiver 328 for coupling to the universal mounting bracket 330. In some examples, a brightness adjuster or dimmer can be provided on the light bar 322 for modifying an illumination level.

FIG. 67 illustrates an exemplary twist-to-lock mechanism 350 for securing a modular accessory component 352 to a universal mounting bracket 354. In some examples, the accessory component 352 (e.g., magnet bar) can include a rotatably-offset receiver 356 configured to secure on the universal mounting bracket 354. The accessory component 352 can be aligned and rotate into position (e.g., into a horizontal position) to lock into place on the universal mounting bracket 354.

The above described aspects provide for a modular workbench system and accessory components with improved packaging efficiency, flexibility, mobility, and scalability for a variety of environments. The use of nesting cabinets whereby the cabinets are packaged in a compact, assembled format can allow for more efficient transportation from the manufacturer to the consumer. The use of detachable couplings can provide for changes in movement, grouping, or coupling of accessory components as needed for improved efficiency in tasks or projects. In examples where bracket attachments or wall attachments are utilized, accessory components can be conveniently removed from the worksurface for use in a given project and easily re-attached, as opposed to traditional accessories that do not separate from wall brackets.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

What is claimed is:

1. A modular workbench system comprising:
a set of cabinets including at least two cabinets, and including at least two of a large cabinet, a medium cabinet, and a small cabinet;
wherein the set of cabinets are modular, capable of multiple different arrangements.

2. The modular workbench system of claim 1 wherein the set of cabinets includes at least three cabinets, and includes at least one of each of the large cabinet, the medium cabinet, and the small cabinet.

3. The modular workbench system of claim 2 wherein the medium cabinet includes a pull-out drawer.

4. The modular workbench system of claim 3 wherein the medium cabinet includes a worktop.

5. The modular workbench system of claim 1 wherein each cabinet of the set of cabinets includes recessed handles.

6. The modular workbench system of claim 1 further comprising at least one of a basket, a shelf, a base shelf, and a hanging rod.

7. The modular workbench system of claim 6 wherein the system further comprises a shelf, and wherein the shelf is reconfigurable within the set of cabinets.

8. The modular workbench system of claim 1 further comprising a set of rails or mounting bracket permitting suspending of at least one cabinet of the set of cabinets from a wall or ceiling.

9. A mounting system for use with a workbench system, the mounting system comprising:
at least one accessory; and
a universal mounting bracket for removably mounting the at least one accessory to the workbench system.

10. The mounting system of claim 9 wherein the universal mounting bracket further comprises one of a latch-locking mechanism, a push-button locking mechanism, or a friction-fit locking mechanism.

11. The mounting system of claim 10 wherein the universal mounting bracket further includes a magnet configured to removably couple the universal mounting bracket to magnetic surfaces.

12. The mounting system of claim 9 further comprising a set of modular cabinets, and wherein the universal mounting bracket removably mounts the at least one accessory to the set of modular cabinets.

13. The mounting system of claim 9 wherein the universal mounting bracket includes a square-slotted post, and wherein the accessory includes an angled aperture configured to receive the square-slotted post.

14. The mounting system of claim 9 wherein the universal mounting bracket further includes a latch for securing a position of the accessory relative to the universal mounting bracket.

15. The mounting system of claim 14 wherein the universal mounting bracket includes a recessed space permitting movement of the latch.

16. The mounting system of claim 9 wherein the at least one accessory includes at least one of a shelf, a tray, a light source, a power supply, a magnet bar, or a magnet bar shelf and the universal mounting bracket includes at least one of a magnetic attachment, a detachable coupling, a bracket, a clamp, a shelf bracket, a clip bracket, a rotating attachment, a bracket sleeve, a keyhole, a cap, a spring-clip bracket, a pivoting coupling, a ball joint, a projecting arm, a hook, a projection, or a two-way recess.

17. The mounting system of claim 9 wherein the at least one accessory further includes a magnet bar removably coupled to the universal mounting bracket.

18. The mounting system of claim 9 wherein the universal mounting bracket includes a cap formed as a sleeve configured to fit over a portion of the at least one accessory.

19. The mounting system of claim 9 wherein the universal mounting bracket further comprises a pivoting coupling for pivoting the at least one accessory at the universal mounting bracket.

20. The mounting system of claim 9 wherein the universal mounting bracket further includes a projecting arm, wherein the projecting arm permits attachment of an additional accessory, such that the at least one accessory includes at least two accessories.
